(19) United States
(12) Patent Application Publication
(10) Pub. No.: US 2026/0301549 A1
(43) Pub. Date: Oct. 1, 2026

(54) CAMERA-BASED DETECTION OF NON-COMPLETED PAYMENT AT SELF- CHECKOUT

(71) Applicant: Toshiba Global Commerce Solutions, Inc., Durham, NC (US)

(72) Inventors: Yeshai Bouskila, Plano, TX (US); Evgeny Shevtsov, Plano, TX (US); Yevgeni Tsirulnik, Frisco, TX (US)

(73) Assignee: Toshiba Global Commerce Solutions, Inc., Durham, NC (US)

(21) Appl. No.: 19/448,306

(22) Filed: Jan. 14, 2026

Related U.S. Application Data
(63) Continuation of application No. 19/095,453, filed on Mar. 31, 2025.

(51) Int. Cl. G07G 3/00; G07G 1/00

(52) U.S. Cl. CPC G07G 3/003; G07G 1/0009

(57) ABSTRACT

Systems and methods of performing camera-based detection of non-completed payment at self-checkout are provided. In one exemplary embodiment, a POS system can monitor self-checkout activity to detect potential non-payment events. The POS system can receive successive image data of a checkout region from an optical sensor and determine a location track for a customer and movement tracks for one or more target objects. The checkout region can include subregions associated with a terminal, a bagging area, and an exit region. The system can associate at least one target object with a possession region around the customer as the customer location track enters the exit region. The system can correlate the possessed objects with transaction data and payment state information for a checkout transaction and, when an item lacks a corresponding paid entry, generate alert data indicating a potential non-payment event.

### CROSS REFERENCE TO RELATED APPLICATIONS

This application is a continuation-in-part of U.S. Pat. App. No. 19/095,453, filed Mar. 31, 2025, which is a continuation-in-part of U.S. Pat. App. No. 18/893,528, filed Sep. 23, 2024, which are all hereby incorporated by reference as if fully set forth herein.

### BACKGROUND

Retailers use point of sale (POS) hardware and software systems to streamline checkout operations and to allow retailers to process sales, handle payments, and store transactions for later retrieval. Each POS system generally includes a number of components including a POS terminal station and a POS bagging station. POS bagging stations can enable customers or retail staff to bag purchased retail items in shopping bags during checkout at the POS systems. POS terminal station devices can include a computer, a monitor, a cash drawer, a receipt printer, a customer display, a barcode scanner, or a debit/credit card reader. POS systems can also include a conveyor belt, a checkout divider, a weight scale, an integrated credit card processing system, a signature capture device, or a customer pinpad device. While POS systems may include a keyboard and mouse, more and more POS systems include monitors with touchscreen technology. Further, the software integrated with POS systems can be configured to handle a myriad of customer-based functions such as product scans, sales, returns, exchanges, layaways, gift cards, gift registries, customer loyalty programs, promotions, and discounts. In a retail environment, there can be multiple POS systems in communication with a server over a network.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1A illustrates one embodiment of a POS system operable to perform item detection in accordance with various aspects as described herein. FIG. 1B illustrates one embodiment of a POS system operable to identify an item that bypasses a checkout transaction in accordance with various aspects as described herein.

FIGS. 2A and 2B illustrate other embodiments of a POS system device or an optical sensor device in accordance with various aspects as described herein. FIG. 2C illustrates another embodiment of a POS system device or an optical sensor device in accordance with various aspects as described herein. FIG. 2D illustrates another embodiment of a POS system device or an optical sensor device in accordance with various aspects as described herein. FIG. 2E illustrates another embodiment of a POS system device or an optical sensor device in accordance with various aspects as described herein.

FIG. 3 illustrates another embodiment of a POS system device or an optical sensor device in accordance with various aspects as described herein.

FIGS. 4A-4D illustrate embodiments of a method performed by a POS system device or an optical sensor device of performing item detection in accordance with various aspects as described herein. FIGS. 4E-4F illustrate embodiments of a method performed by a POS system device or an optical sensor device of a “ghost scan” detection in accordance with various aspects as described herein. FIG. 4G illustrates one embodiment of a method performed by a POS system device or an optical sensor device of a “cart-to-bag” detection with or without scanning in accordance with various aspects as described herein. FIGS. 4H-1 and 4H-2 illustrate one embodiment of a method of identifying that an item bypasses a checkout transaction in accordance with various aspects as described herein.

FIG. 5 illustrates another embodiment of a POS system device or an optical sensor device in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

A self-checkout station can utilize weight-based item security to ensure consumers place scanned items in a shopping cart or bag. Further, a computer vision system can capture video of activities associated with a self-checkout station and can analyze consumer interaction and behavior based on the captured video. In addition, certain models and algorithms can be integrated at different stages in the processing of the captured video. These models and algorithms can extract useful information from the captured video and can process the captured video to represent various stages of consumer interaction with the self-checkout terminal. For instance, a computer vision system can be utilized to detect a consumer placing scanned or weighed items in a bagging area. The computer vision system can also detect unscanned or unweighed items being transferred to a bagging area and in response, can generate an alert to indicate a possible fraudulent activity. As such, a computer vision system can be configured to evaluate certain behavior of consumers at a self-checkout station to improve detection of non-fraudulent and possible fraudulent activities by consumers.

In this disclosure, embodiments described herein can include the use of a computer vision system to track a target object (e.g., retail item, hand, purse, smartphone, cart, basket, plastic bag) from a certain starting point (e.g., cart, basket) to a certain ending point (e.g., bagging area) about a POS system (e.g., self-checkout station), checkout station) and can include tracking the trajectory of the target object. When the track of the target object about the POS system is completed, processing circuitry of the POS system or the computer vision system can evaluate, based on heuristics, a set of rules or criteria to validate that the track of the target object corresponds to a “cart to bag” scenario where an object is transferred from a cart or basket to a bagging area of the POS system without being scanned. If the evaluation indicates a “cart to bag” scenario, then the target object is identified as being transferred to the bagging area without being scanned. The rules or criteria to identify that a target object is transferred to the bagging area without being scanned can include: the target object is scanned more than once by the POS system; the target object is scanned by a portable scanning device of the POS system; the target object entered less than two POS subregions (e.g., bagging area, container area, scanning platform, scanning window, scanning platform) in a region about the POS system; the target object performed less than two steps in the POS subregions; a maximum distance between the target object track and the subregion associated with the bagging area is less than a certain distance threshold; the ending POS subregion of the target object track is not the POS subregion associated with the bagging area; the starting POS subregion of the target object track is the POS subregion associated with the bagging area; a duration from the target object starting in any POS subregion to entering the subregion associated with the bagging area is less than a certain duration threshold; the target object track corresponds to the POS subregion associated with the scanning window; an area of the target object displayed in each successive image is less than a certain area threshold associated with an object having a certain minimum size; a duration in which the target object is at least a certain minimum area is at least a certain duration threshold; the like; or any combination thereof.

In another exemplary embodiment, when the track of the target object about the POS system is completed, the processing circuitry of the POS system or the computer vision system can generate statistics associated with the track of the target object, extract features from those statistics, and apply a machine learning model to the extracted features to obtain a probability that the target object is transferred from the shopping cart to the bagging area without being scanned. The statistics associated with the track of the target object and the resulting extracted features are related to objects detected in a region about the POS system and POS subregions in the POS region such as a POS subregion associated with a container (e.g., shopping cart, shopping bag, shopping basket), a POS subregion associated with the scanning window, and/or a POS subregion associated with the bagging area.

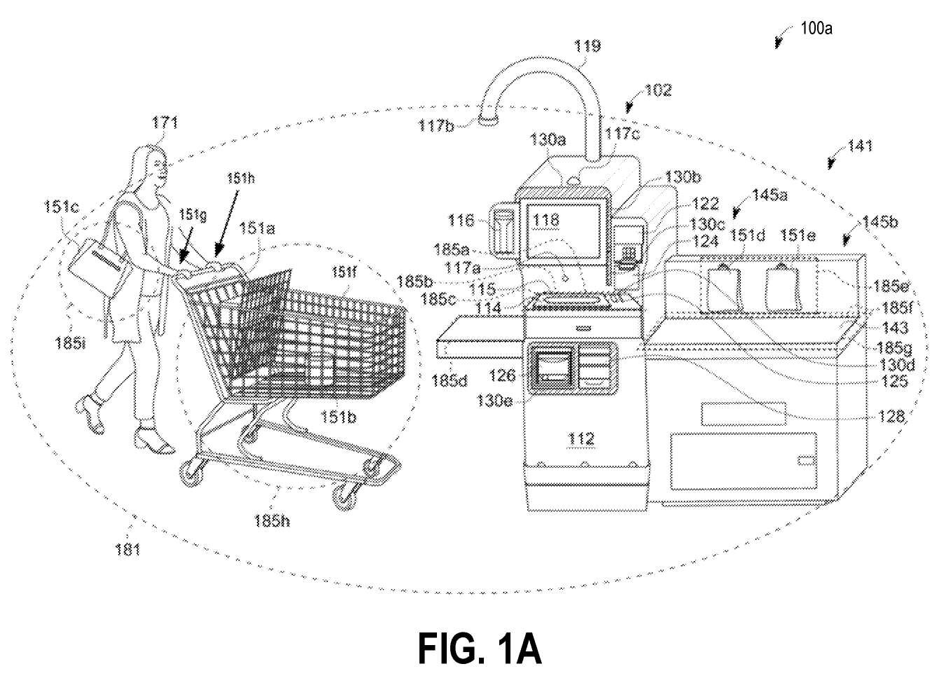

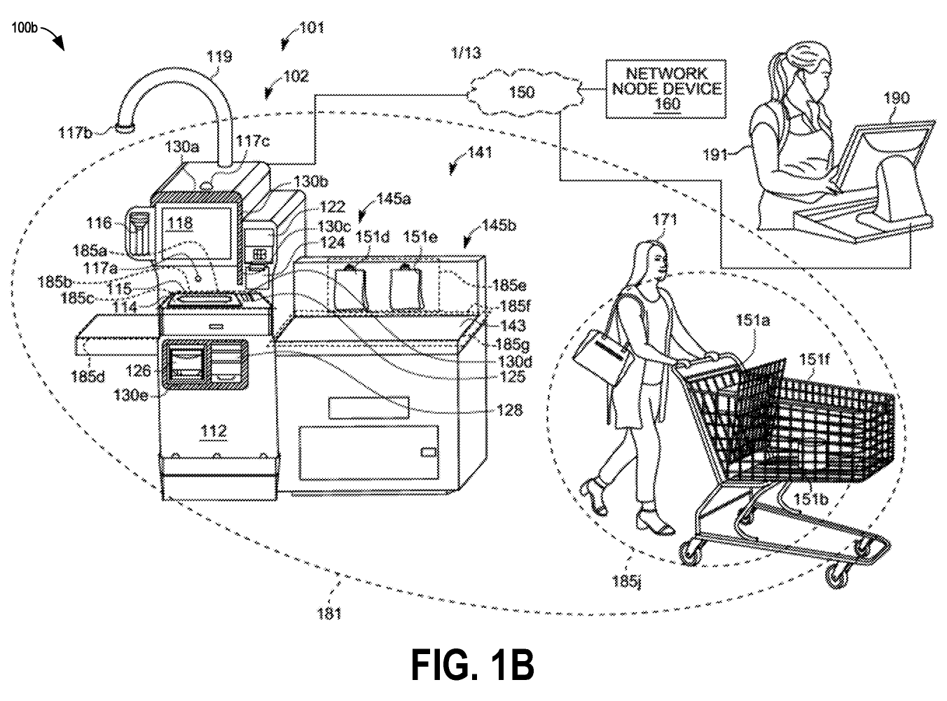

FIG. 1A illustrates one embodiment of a POS system 100a operable to perform item detection at point of sale in accordance with various aspects as described herein. As shown in FIG. 1A, the POS system 100a (e.g., checkout station device, self-checkout station device) can be communicatively coupled to a network node (e.g., server) over a network (e.g., Ethernet, WiFi, Internet). The POS system 100a can include a terminal station device 102 and a bagging station device 141. The terminal station device 102 can include a housing 112, a scan platform 114 having a scanner window 115 through which an optical scanner device disposed under the scanner window 115 can scan a visual object identifier code (e.g., barcode, QR code) disposed on an object 151a,b (e.g., retail item) while on, above or about the scanner window 115, another optical scanner 116 (e.g., portable or handheld scanner), a display device 118 (e.g., touchscreen), a payment processing mechanism 122 (e.g., credit card transaction device), a printer 124, a coupon slot mechanism 125, a cash acceptor mechanism 126, a change (e.g., coins, cash) interface mechanism 128, the like, or any combination thereof. In addition, the terminal station device 102 can be configured to include a set of light emitting element (LED) devices 130a-e (collectively, LED devices 130). The housing 112 can be configured to include a cabinet that contains a processing circuitry operable to control the operations and functions of the POS system 100a. Each LED device 130a-e can be configured to be individually or collectively controlled by a processing circuit of the POS system 100a to indicate certain contextual information to a consumer or a retail store clerk. Although not explicitly shown herein, the housing 112 can also contain cabling and other functional components that communicatively couple the POS system 100a to a network (e.g., Ethernet, WiFi, Internet) or a network node (e.g., server) over the network or that communicatively couple the terminal station device 102 to the bagging station device 141. The bagging station device 141 can include a bagging area 143 associated with a load sensor device operable to measure a weight of any object placed in the bagging area 143.

In FIG. 1A, each scanner device 115, 116 can be configured as an optical scanner device operable to scan a visual object identifier code (e.g., barcode, QR code) disposed on an object 151a,b (e.g., retail item) that a consumer intends to purchase via the POS system 100a. The scanner device 116 can be configured as a hand-held, battery-operated scanner that a consumer or a clerk can remove from its battery charging dock to scan barcodes on retail items such as without having to remove them from a shopping cart. Each visual object identifier code can represent one of a set of object identifiers (e.g., UPCs), with each identifier being specific to a certain object (e.g., retail item, trade item) and represented by a series of characters (e.g., numeric characters, alphabetic characters, alphanumeric characters). Universal Product Code (UPC), which can refer to UPC-A, consists of a sequence of twelve characters (e.g., 12 numeric characters) that are uniquely assigned to each object. Along with the related International Article Number (EAN) barcode, the UPC is the barcode mainly used for scanning retail items at the point of sale, per the specifications of the international GS1 organization. In one example, a UPC-A barcode consists of a sequence of twelve characters (e.g., 12 digits), which are made up of four sections: a number system character, a five-character manufacturing number, a five-character item number and a check character.

In FIG. 1A, the scanner device 115 can include the scanner window 114 and can be operable to perform dual scanner and weight scale functions to allow the retail item to be contemporaneously scanned and weighed for purchase by a consumer. The scan platform 114 can be configured to allow an object to be placed on the scan platform 114 to enable the object to be weighed by the weight scale function. The display 118 can be operable to display information associated with retail items being purchased by a consumer. The payment processing mechanism 122 can be configured with a pinpad device operable to accept a non-cash payment vehicle (e.g., credit card or debit card), while the printer 124 can be configured to print receipts or coupons. The coupon slot mechanism 125 can include a generally elongated slot configured to receive coupons being redeemed by a consumer. The cash acceptor mechanism 126 can be operable to receive cash (e.g., paper money, coins) from the consumer for the retail items being purchased by the consumer. The change interface mechanism 128 can be operable to provide change to the consumer in the form of paper money or coins.

Furthermore, the terminal station device 102 can also include optical sensor devices 117a-c (e.g., camera). Each optical sensor device 117a-c can be operable to capture an image of at least a portion of the POS system 100a, capture an image about the POS system 100a that includes a POS region 181, capture an image of the environment surrounding the POS system 100a, capture an image of one or more surfaces of the POS system 100a such as the scan platform 114 or the bagging area 143, or the like. The optical sensor device 117a can have a field of view that includes the scan platform 114, the scan window 115, the environment before the POS system 100a, or the like. The optical sensor device 117b can have a field of view that includes the POS system 100a, the POS region 181 about the POS system 100a, the environment about the POS system 100a, or the like. While the optical sensor device 117b is shown in FIG. 1A at the end of an extension mechanism 119 (e.g., extension pole) of the POS system 100a that extends the optical sensor device 117b above the POS system 100a, in other embodiments, the optical sensor device 117b can be disposed on a ceiling surface above the POS system 100a, positioned on the POS system 100a, or the like. The optical sensor device 117c can be operable to capture the environment about the POS system 100a such as to detect a consumer entering or exiting the POS region 181.

In one exemplary operation of the POS system 100a of FIG. 1A, the POS system 100a or the optical sensor device 117a-c can obtain data that represents a set of successive images of the POS region 181 captured by the optical sensor (e.g., camera) of the optical sensor device 117a-c as the object 151a-e is moved in the POS region 181 such as a hand 151g,h of a consumer 171 grabbing the object 151a,b and removing it from a container 151f (e.g., cart, basket, bag) and placing it in the bagging area 143. The processing circuitry of the POS system 100a can receive from the optical sensor device 117a-c the successive image data associated with the POS region 181. Additionally or alternatively, the optical sensor device 117a-c can receive from the optical sensor the successive image data associated with the POS region 181. The successive image data can include display of the POS region 181 including the POS system 100a, the consumer 171 and the container 151f (e.g., cart, basket, bag) proximate the POS system 100a. The POS region 181 can include a set of POS subregions 185a-i. The set of POS subregions 185a-i can include: a POS subregion 185a associated with an extended area about the scanning platform 114 such as to include objects that when placed on the scanning platform 141 can extend outside the scanning platform 141; a POS subregion 185b disposed in the POS subregion 185a and associated with the scanning platform 114; a POS subregion 185c disposed in the POS regions 185a,b and associated with the scanning window 115; a POS subregion 185d associated with a shelf of the POS system 100a, which can be used to place a container (e.g., basket, bag) while objects disposed in the container are scanned; a POS subregion 185e associated with a bag holder 145a,b having bags 151d,e for use by the consumer 171 during self-checkout to bag an object 151a,b; a POS subregion 185f associated with an extended area about the bagging area 143 such as to include objects that when placed in the bagging area 143 can extend outside the bagging area 143, a POS subregion 185g associated with the bagging area 143; a POS subregion 185h associated with the container 151f; a POS region 185i associated with a personal object 153 (e.g., clothes, hat, purse, handbag, wallet, eyewear, phone, laptop, shopping bag, coffee, soda, return item) carried or worn by the consumer 171; the like, or any combination thereof. The objects 151a,b disposed in the container 151f can include a visual object identifier code (e.g., barcode, QR code) disposed on that object 151a,b (e.g., retail item), with each visual object identifier code being configured to be scanned by the a scanner device to obtain an object identifier.

Furthermore, the POS system 100a or the optical sensor device 117a-c can apply pre-processing to the data of each successive image. For instance, the POS system 100a or the optical sensor device 117a-c can apply to the data of each successive image a filter to reduce image artifacts or noise; convert color pixels to grayscale pixels; orient the POS region 181 to the same orientation; crop a perimeter of the POS region 181; change image resolution; enhance image quality; the like; or any combination thereof. Further, the POS system 100a or the optical sensor device 117a-c can determine a perimeter of the POS region 181 based on the successive image data. In addition, the POS system 100a or the optical sensor device 117a-c can determine a perimeter for any or all of the POS subregions 185a-i. For instance, the POS system 100a can define, for each successive image, the POS region 181 or any POS subregion 185a-i based on the successive image data. The POS system 100a or the optical sensor device 117a-c can determine, for each successive image, a location of an object 151a-h in the POS region 181 based on the successive image data. The POS system 100a or the optical sensor device 117a-c can detect activity in one of the set of POS subregions 185a-i based on the successive image data. The POS system 100a or the optical sensor device 117a-c can then determine that the activity in the detected POS subregion 185a-i corresponds to the object 151a-h in that POS subregion 185a-i. Further, the POS system 100a or the optical sensor device 117a-c can identify the object 151a-h as starting an object movement track in the identified POS subregion 185a-i. The object movement track can include a set of successive locations of the object 151a-h as it is moved in the POS region 181 based on the successive image data, with each successive location being related to a corresponding successive image. In one example, the POS system 100a or the optical sensor device 117a-c can determine that the detected activity in the POS subregion 185h corresponds to the object 151a (e.g., retail item) disposed in the container 151f (e.g., shopping cart) being removed from that container 151f. In another example, the POS system 100a or the optical sensor device 117a-c can determine that the detected activity in the POS subregion 185i corresponds to the object 153 (e.g., purse) being removed from the shoulder of the consumer 171 . In another example, the POS system 100a or the optical sensor device 117a-c can determine that the detected activity in the POS subregion 185c corresponds to an object 151d,e (e.g., plastic bag) being removed from its corresponding shopping bag holder 145a,b.

Moreover, the POS system 100a or the optical sensor device 117a-c can determine the object movement track having a set of successive object locations of the object 151a-h as the object 151a-h is moved in the POS region 181 based on the successive image data. The POS system 100a or the optical sensor device 117a-c can identify those POS subregions 185a-i that correspond to the object movement track of the object 151a-h based on the successive image data and the object movement track. Further, the POS system 100a or the optical sensor device 117a-c can identify the target object 151a-h as starting or ending the object movement track in at least one of the set of POS subregions 185a-i. The POS system 100a or the optical sensor device 117a-c can determine a duration between the starting and ending POS subregions 185a-i that correspond to the object movement track of the object 151a-h based on the successive image data or the object movement track. The POS system 100a or the optical sensor device 117a-c can also determine a chronological order of the identified POS subregions 185a-i based on the successive image data or the object movement track. In addition, the POS system 100a or the optical sensor device 117a-c can determine that the object 151a-h is transferred to the POS subregion 185f,g associated with the bagging area 143 without being scanned based on a set of criteria associated with the set of POS subregions 185a-i or the object movement track. The set of criteria can include: a first criteria associated with a determination that the object 151a-h is transferred to the POS subregion 185f,g associated with the bagging area 143 without being scanned based on the number of POS subregions 185a-i that correspond to the object movement track; a second criteria associated with a determination that the object 151a-h is transferred to the POS subregion 185f,g associated with the bagging area 143 without being scanned based on whether the POS subregion 185c associated with the scanning window 115 corresponds to the object movement track; a third criteria associated with a determination that the object 151a-e is transferred to the POS subregion 185f,g associated with the bagging area 143 without being scanned based on a starting or ending POS subregion 185a-i that corresponds to the object movement track; a fourth criteria associated with a determination that the object 151a-e is transferred to the POS subregion 185f,g associated with the bagging area 143 without being scanned based on a set of distances between the set of successive locations of the object movement track and that POS subregion 185f,g; a fifth criteria associated with a determination that the object 151a-e is transferred to the POS subregion 185f,g associated with the bagging area 143 without being scanned based on a set of distances between the set of successive locations of the object movement track and that POS subregion 185f,g and on the duration between the starting and ending POS subregions 185a-i of the object 151a-e that correspond to the object movement track; the like; or any combination thereof.

In another embodiment, the POS system 100a or the optical sensor device 117a-c can detect that the same object 151a,b is scanned more than one time by the optical scanning device based on the successive image data or the object movement track. The set of criteria can further include another criteria associated with a determination that the object 151a,b is transferred to the POS subregion 185f,g associated with the bagging area 143 without being scanned responsive to a determination that the same object 151a,b is scanned more than once by the optical scanning device.

In another embodiment, the POS system 100a or the optical sensor device 117a-c can determine that the object 151a-b is scanned by the portable scanning device 116 based on the successive image data or the object movement track. The set of criteria can further include another criteria associated with a determination that the object 151a,b is transferred to the POS subregion 185f,g associated with the bagging area 143 without being scanned responsive to the determination that the object 151a,b is scanned by the portable scanning device 116.

In another exemplary operation of the POS system 100a of FIG. 1A, the POS system 100a or the optical sensor device 117a-c can obtain data that represents the set of successive images of the POS region 181 captured by the optical sensor 117a-c (e.g., camera) when an object 151a-e is interacted with in the POS region 181 such as by a hand 151f,g of a consumer 171 grabbing the object 151a,b, removing it from the container 151f (e.g., cart, basket, bag), and then transferring the object 151a,b to the bagging area 143. The processing circuitry of the POS system 100a can receive from the optical sensor device 117a-c the successive image data associated with the POS region 181. Additionally or alternatively, the optical sensor device 117a-c can receive from the corresponding optical sensor the successive image data associated with the POS region 181. The POS system 100a or the optical sensor device 117a-c can detect, classify or identify a set of objects 151a-h (e.g., hand, retail item, cart, basket, purse, smartphone, consumer, bag, portable scanner, or the like) displayed in the set of successive images based on the successive image data. The POS system 100a can detect an interacted object 151a-e that is interacted with in the POS region 181 as displayed in the set of successive images based on the set of detected objects and the successive image data. The POS system 100a or the optical sensor device 117a-c can determine a set of successive image segmentation masks that visually represents segmentation of the interacted object 151 a-e, the set of detected objects and the set of POS subregions 185a-i displayed in the set of successive images based on the successive image data. The POS system 100a or the optical sensor device 117a-c can determine a set of detected object characteristics based on the set of successive image segmentation masks. The set of detected object characteristics can include information such as detected object mask area, distance between detected objects 151a-h (e.g., distance between retail item and hand of consumer, distance between retail items, distance between retail item and shopping cart), distance between a detected object 151a-h and a POS subregion 185a-i, the like, or any combination thereof. The POS system 100a or the optical sensor device 117a-c can extract, based on the set of detected object characteristics, a set of interacted object track characteristics related to the interaction with the interacted object 151a-e in the POS region 181 as displayed in the set of successive images based on the set of detected object characteristics. The set of interacted object track characteristics can be associated with all or a portion of an object movement track of the interacted object 151a-e with the object movement track representing a set of successive locations of the interacted object 151a-e as the interacted object 151a-e is moved in the POS region 181 based on the successive image data. Further, each successive location corresponds to a certain one of the set of successive images.

Furthermore, the set of interacted object track characteristics can include a duration of all or a portion of the object movement track of the interacted object 151a-e; a distance between the interacted object 151a-e and another detected object 151a-h; a distance between the interacted object 151a-e and a POS subregion 185a-i; a distance between the interacted object 151a-e and an object 151g,f (e.g., hand) that interacts with the interacted object 151a-e; a distance between the interacted object 151a-e and a container 151f; an average intersection over the POS subregion 185f,g associated with the bagging area 143; an average distance the interacted object 151a-e moved per each successive image; a maximum distance the interacted object 151a-e is moved during the interaction with the interacted object 151a-e; a distance between the interacted object 151a-e and the POS subregion 185f,g associated with the bagging area 143 on an initial successive image for which the interacted object 151a-eis detected; a distance between the interacted object 151a-e and the POS subregion 185f,g associated with the bagging area 143 on a final successive image for which the interacted object 151a-e is detected; a percentage of the set of successive images (e.g., starts from an initial successive image for which the interacted object 151a-e is detected and ends at a final successive image for which the interacted object 151a-e is detected) for which the interacted object 151a-e is detected in the POS subregion 185f,g associated with the bagging area 143; a percentage of the set of successive images (e.g., starts from an initial successive image for which the interacted object 151a-e is detected and ends at a final successive image for which the interacted object 151a-e is detected) for which the interacted object 151a-e is detected in the POS subregion 185a-c associated with the scanning platform 115; a percentage of the set of successive images (e.g., starts from an initial successive image for which the interacted object 151a-e is detected and ends at a final successive image for which the interacted object 151a-e is detected) for which the interacted object 151a-e is not detected in any POS subregion 185a-i; a percentage of the set of successive images (e.g., starts from an initial successive image for which the interacted object 151a-e is detected and ends at a final successive image for which the interacted object 151a-e is detected) for which the interacted object 151a-e is simultaneously detected in at least two POS subregions 185a-c, 185f-g; a percentage of the set of successive images (e.g., starts from an initial successive image for which the interacted object 151a-e is detected and ends at a final successive image for which the interacted object 151a-e is detected) for which the object 151f,g is undetected in the POS region 181; a percentage of the set of successive images (e.g., starts from an initial successive image for which the interacted object 151a-e is detected and ends at a final successive image for which the interacted object 151a-e is detected) for which the interacted object 151a-e is the only object of the set of objects 151a-h that is detected in the POS region 181; a percentage of the set of successive images (e.g., starts from an initial successive image for which the interacted object 151a-e is detected and ends at a final successive image for which the interacted object 151a-e is detected) for which the container 151f is detected in the POS region 181; a percentage of the set of successive images (e.g., starts from an initial successive image for which the interacted object 151a-e is detected and ends at a final successive image for which the interacted object 151a-e is detected) for which the interacted object 151a,b has been indicated as being scanned by the POS system 100; a minimum, maximum or average size of a mask area of the interacted object 151a,b in the set of successive images; the like; or any combination thereof. The set of interacted object track characteristics can include interacted object track characteristics that are determined over the entirety of the object movement track of the interacted object 151a-e or a certain portion of the object movement track of the interacted object 151a-e, a beginning portion (e.g., initial second(s)) of the object movement track of the interacted object 151a-e, an ending portion (e.g., last second(s)) of the object movement track of the interacted object 151a-e, the like, or any combination thereof. For instance, the set of interacted object track characteristics can include one or more interacted object track characteristics associated with the entirety of the object movement track of the interacted object 151a-e, one or more interacted object track characteristics associated with a portion of the object movement track of the interacted object 151a-e that corresponds to the bagging area 143, and one or more interacted object track characteristics associated with the last second(s) of the object movement track of the interacted object 151a-e.

The distance between the interacted object 151a-e and another detected object 151a-h can be further classified or indicated as follows: only the interacted object 151a-e was detected during the interaction with the interacted object 151a-e; another object 151a-h is detected during the interaction with the interacted object 151a-e and the other object 151a-h is considered distant (e.g., minimum or average distance between the interacted object 151a-e and the other object 151a-h is greater than a certain distance such as 100a pixels); another object 151a-h is detected during the interaction with the interacted object 151a-e but the other object 151a-h is considered a moderate distance (e.g., average distance between the interacted object 151a-e and the other object 151a-h is a certain distance range such as 50 to 100a pixels); another object 151a-h is detected during the interaction with the interacted object 151a-e and the other object 151a-h is considered proximate (e.g., average distance between the interacted object 151a-e and the other object 151a-h is less than a certain distance such as 50 pixels); the like; or any combination thereof.

The distance between the interacted object 151a-e and the detected object associated with a hand 151g,h can be further classified as follows: the object 151g,h was not detected during any interaction with the interacted object 151a-e; the object 151g,h is detected during the interaction with the interacted object 151a-e and the object 151g,h is considered distant (e.g., minimum or average distance between the interacted object 151a-e and the object 151g,h is greater than a certain distance such as 100a pixels); the object 151g,h is detected during the interaction with the interacted object 151a-e but the object 151g,h is considered a moderate distance (e.g., average distance between the interacted object 151a-e and the object 151g,h is a certain distance range such as 50 to 100apixels); the object 151g,h is detected during the interaction with the interacted object 151a-e and the object 151g,h is considered proximate (e.g., average distance between the interacted object 151a-e and the object 151g,h is less than a certain distance such as 50 pixels); the like; or any combination thereof.

The distance between the interacted object 151a-e and the detected object associated with the container 151f can be further classified as follows: the object 151f was not detected during any interaction with the interacted object 151a-e; the object 151f is detected during the interaction with the interacted object 151a-e and the object 151f is considered distant (e.g., minimum or average distance between the interacted object 151a-e and the object 151f is greater than a certain distance such as 100a pixels); the object 151f is detected during the interaction with the interacted object 151a-e but the object 151f is considered a moderate distance (e.g., average distance between the interacted object 151a-e and the object 151f is a certain distance range such as 50 to 100a pixels); the object 151f is detected during the interaction with the interacted object 151a-e and the object 151f is considered proximate (e.g., average distance between the interacted object 151a-e and the object 151f is less than a certain distance such as 50 pixels); the like; or any combination thereof.

In the current embodiment, the POS system 100a or the optical sensor device 117a-c can apply an artificial intelligence model (e.g., machine learning circuit, neural network circuit) to the set of interacted object track characteristics to obtain an indication that the interacted object 151a-e is transferred to the POS subregion 185f,g associated with the bagging area 143 without being scanned and a corresponding confidence level. The artificial intelligence model can correspond to supervised learning algorithms such as linear regression, logistic regression, decision trees, random forest, support vector machines (SVM), k-nearest neighbors (k-NN), naive Bayes, gradient boosting machines (e.g., XGBoost, LightGBM, CatBoost), or the like; unsupervised learning algorithms such as k-means clustering, hierarchical clustering, principal component analysis (PCA), independent component analysis (ICA), Gaussian mixture models (GMM), t-distributed stochastic neighbor embedding (t-SNE), autoencoders, or the like; semi-supervised learning algorithms such as self-training, co-training, label propagation, graph-based semi-supervised learning, or the like; reinforcement learning algorithms such as Q-learning, deep Q-networks (DQN), policy gradient methods (e.g., REINFORCE), proximal policy optimization (PPO), actor-critic algorithms, Monte Carlo tree search (MCTS), or the like; deep learning algorithms such as convolutional neural networks (CNNs), recurrent neural networks (RNNs), long short-term memory (LSTM) networks, generative adversarial networks (GANs), transformers, autoencoders, attention mechanisms, or the like; ensemble learning algorithms such as bagging (e.g., Bootstrap Aggregating), boosting (e.g., AdaBoost, Gradient Boosting), stacking, voting classifier, or the like; the like; or any combination thereof. Further, the artificial intelligence model can be implemented via software, firmware, or circuitry in the POS system 100a, the optical sensor device 117a-c, a network node operationally coupled to the POS system 100a over a network, the like, or any combination thereof. For an implementation that includes software or firmware, processing of the corresponding portion of the artificial intelligence model can be performed across one or more processing circuits of the POS system 100a or the optical sensor device 117a-c. For an implementation that includes circuitry, the processing circuitry of the POS system 100a or the optical sensor device 117a-c can interface with the artificial intelligence circuitry. For an implementation where the network node performs the artificial intelligence model, the POS system 100a can communicate with the network node over the network to enable the network node to perform the artificial intelligence model.

Furthermore, the artificial intelligence model can be trained based on a set of predetermined interacted object track characteristics related to an interacted object from an initial detection to a last detection in the POS region 181 that is proximate the POS subregion 185f,g associated with the bagging area 143 and without being scanned. The set of predetermined interacted object track characteristics can include the following: a large number of data records (e.g., 100a, 1000, 10000, 100000 data records); each record can include a set of predetermined interacted object track characteristics, with the track being represented from initial detection to last detection of that object in the POS region; each record includes aggregated detected object characteristics for at least two successive images; no restrictions on data records based on where the interacted object 151a-e is initially detected; data records restricted to those where the interacted object 151a-e is last detected proximate the POS subregion 185f,g associated with the bagging area 143; the like; or any combination thereof. The POS system 100a or the optical sensor device 117a-c can then determine that the interacted object 151a-e is transferred to the POS subregion 185f,g associated with the bagging area 143 without being scanned based on the indication and the corresponding confidence level. For instance, the POS system 100a or the optical sensor device 117a-c can determine that the interacted object 151a-e is transferred to the POS subregion 185f,g associated with the bagging area 143 without being scanned if the corresponding confidence level is at least a certain confidence threshold (e.g., 50%, 75%, 80%, 85%, 90%, 95%, 98%, 99%). The POS system 100a or the optical sensor device 117a-c can send an indication that the interacted object 151a-e is transferred to the POS subregion 185f,g associated with the bagging area 143 without being scanned. In one example, the optical sensor device 117a-c can send, to the POS system 100a, an indication that the interacted object 151a-e is transferred to the POS subregion 185f,g associated with the bagging area 143 without being scanned. In another example, the POS system 100a can send, to an LED device 130a-e, an indication to enable illumination by that LED device 130a-e so as to alert a clerk. In yet another example, the POS system can send, to a network node, an indication that the interacted object 151a-e is transferred to the POS subregion 185f,g associated with the bagging area 143 without being scanned.

The present disclosure also provides systems and methods of implementing different schemes for trusted consumers and regular consumers. Trusted consumers, having demonstrated consistent trustworthy behavior, receive fewer alerts during checkout at a POS system, as they are less likely to engage in fraudulent activities. However, a POS system can monitor their behavior to account for potential misrecognition. To reduce false positives while maintaining behavioral control, the system can adjust system parameters—such as thresholds and global settings—in its business logic. This parameter relaxation not only improves the user experience for trusted consumers but can also increase system performance by reducing power consumption, heat generation, computational resource usage, or the like. System parameters can be estimated using real data and optimized to achieve a higher true positive rate while maintaining an acceptable false positive rate. A true positive rate can be the proportion of actual fraudulent activities correctly identified by the system as fraud. Further, a higher true positive rate indicates that the system more effectively detects fraudulent behavior when it occurs. For trusted consumers, the system can leverage prior knowledge of their trustworthiness, resulting in reduced expectations of true positives. However, occasional false positives may still occur due to model inference errors or object tracking issues. A false positive rate can be the proportion of non-fraudulent activities incorrectly identified by the system as fraud. Further, a higher false positive rate can mean that the system more frequently raises unnecessary alerts for trusted or regular consumers who are not engaging in fraudulent behavior. To enhance system stability, parameter relaxation can be applied, reducing the false positive rate without compromising the true positive rate.

Furthermore, the system can implement several techniques for trusted consumers to enhance efficiency and reduce resource usage. One technique can be the reduction of the frame rate, as the system can rely on less detailed monitoring for trusted consumers' actions. This adjustment can decrease system load and conserve computational resources. Additionally, the system can relax specific business logic parameters for trusted consumers, including POS subregion size, event duration, track duration, event coincidence settings, or the like. In a ghost-scan use case, for example, the item size threshold can be increased such as from 430 pixels to 500 pixels, the minimum track duration can be extended such as from 0.45 seconds to 0.8 seconds, the minimum item time in the POS subregion associated with the scanning window can be lengthened from 110 milliseconds to 200 milliseconds, and the area of the POS subregion associated with the bagging area can be expanded. These parameter adjustments can maintain monitoring accuracy while reducing false positives, ultimately improving the system’s performance when dealing with trusted consumers. In the Cart-To-Bag use case, for example, the system can decrease the bag zone parameter, increase the minimum time required for the track existence before appearing in the POS subregion associated with the bagging area, and increase the expected time during which the item should maintain a stable size larger than the minimum threshold size of an item. These parameter adjustments can maintain monitoring accuracy while minimizing false positives, ultimately optimizing the system’s performance when dealing with trusted consumers.

In POS systems, a ghost scan occurs when an item is registered as scanned without actually being present or correctly scanned. Fraudulent ghost scans can be carried out by both employees and consumers. In the case of employee fraud, an employee may intentionally scan an item multiple times or manipulate the checkout process to distort inventory or financial records. Consumer fraud involves deliberate actions to deceive the POS system and reduce the cost of purchases. This can include barcode switching, where a cheaper barcode is placed over a more expensive item's original barcode, or skip scanning, where a customer passes an item over the scanner without registering it. Barcode replication is another tactic, where fake barcodes are printed and placed over original ones to trick the system. Consumers may also manipulate self-checkout systems by entering incorrect item codes, particularly for weighed products, or by using mobile payment apps in deceptive ways, such as showing falsified payment confirmation screens. Ghost scans can cause significant financial losses and inventory discrepancies for retailers, making it crucial to detect and prevent them.

Furthermore, in a “ghost scan” scenario, where an item is registered as scanned without actually being present or correctly scanned by the POS system, the time required to complete the fraudulent action by the customer can vary based on the method used and the POS system constraints. A customer performing a barcode spoof can take as little as one tenth (0.1) to three seconds, where a customer can quickly scan a different barcode instead of the actual retail item’s barcode. A customer performing a phantom barcode entry, if manual barcode input is allowed, can typically take one to three seconds, depending on the interface speed of the POS system. A customer that performs a pre-scanned or fake scan motion can occur within one tenth (0.1) to three seconds, where the customer mimics the scanning motion without actually registering the correct barcode. Another method, intentional scanner misalignment, can requires one to five seconds as the customer positions the item to appear scanned while ensuring the barcode is never actually read. The exact time needed depends on factors such as scanner responsiveness, system alert mechanisms, and the customer’s experience.

In one exemplary embodiment, a POS system can obtain one of a set of customer trust levels associated with a customer account that corresponds to a current transaction. Customer trust levels in the context of how a merchant perceives its customers can be a reflection of the confidence the merchant places in individual customers based on their behavior, history, loyalty, or the like. At a low trust level, the merchant can have limited confidence in the customer due to behaviors like irregular purchasing, late payments, a lack of sufficient purchase history, or the like. For instance, a customer who only shops occasionally or makes returns frequently may be categorized as a low trust level. The merchant may require additional verification, such as prepayment or stricter return policies, when dealing with such customers. Moving to a moderate trust level, the merchant can have some confidence in the customer based on a history of timely payments or consistent purchasing, though the relationship remains somewhat transactional. For instance, a customer who makes regular but smaller purchases and has a decent payment record but hasn’t yet built significant loyalty or trust in the eyes of the merchant. The merchant may offer more lenient return policies, promotions, or loyalty rewards, but still can require some oversight, such as limiting credit options. At the high trust level, the merchant can establish a strong, positive relationship with the customer, marked by consistent and timely purchases, loyalty, and perhaps a long-standing history with the merchant. For instance, a customer who regularly shops, pays on time, and engages with store promotions or loyalty programs would be considered a high trust level. The merchant may offer benefits like flexible payment options, personalized discounts, and exclusive deals, trusting that the customer can follow through on transactions and honor return policies without complications. A very high trust level can be reserved for customers who have built an exceptionally strong relationship with the store, demonstrating loyalty, reliability, and integrity over time. For instance, a very high trust level customer can be someone who consistently makes large purchases, has a flawless payment history, and frequently recommends the merchant to others. The merchant may offer premium services such as credit extensions, personalized offers, or special treatment, trusting the customer implicitly and relying on them to continue their positive relationship with the merchant. Each trust level can enable the merchant to determine how to engage with its customers and manage risk while fostering loyalty.

Furthermore, the POS system can send, to a network node over a network, an indication that includes a request for one of the set of customer trust levels associated with the customer account that corresponds to the current transaction. In response, the POS system can receive, from the network node over the network, an indication that includes the one of the set of customer trust levels associated with the customer account that corresponds to the current transaction. Additionally or alternatively, the system can select one of the set of customer trust levels associated with the customer account based on information related to the customer account. The system can then select, based on the target customer trust level, one set of sets of predetermined “cart to bag” criteria to enable a determination that the target object of the current transaction is transferred to the POS subregion associated with the bagging area with or without being scanned based on the selected set of predetermined “cart to bag” criteria. The system can obtain data that represents a set of successive images of the POS region captured by the optical sensor device as a target object is moved in the POS region. Further, the system can determine that the target object is transferred to the POS subregion associated with the bagging area with or without being scanned based on the selected set of predetermined “cart to bag” criteria, the set of POS subregions and an object movement track having a set of successive object locations of the target object as the target object is moved in the POS region. Each successive location can be related to a certain one of the set of successive images of the POS region. In addition, the system can send an indication that the target object is transferred to the POS subregion associated with the bagging area with or without being scanned.

The present disclosure further provides systems and methods of detecting instances where a shopper or cashier scans one item—typically a lower-cost item—while placing a different item in the bagging area during self-checkout, which is also referred to as a “ghost scan” scenario. A POS system can identify when the second item has not been scanned and can trigger an alert notification accordingly. For example, a POS system can utilize a parallel tracking algorithm to monitor multiple items simultaneously during the self-checkout process. For instance, if a shopper scans a lower-cost bottle of wine while placing a more expensive bottle in the bagging area, the POS system can independently track both items. It can confirm that the cheaper item was scanned while simultaneously tracking the movement of the expensive item until it is placed in the bagging area or on the shelf. If the POS system detects that the expensive item has bypassed the scanning process despite a barcode scan being registered for a different item, the POS system can trigger an alert such as to notify a clerk. The cart-to-bag detection techniques described herein can be applied to all tracked items, such as by applying parallel processing capability to ensure differentiation, enabling precise fraud detection. The POS system can be powered by several components, including a semantic segmentation model for object classification, a tracking algorithm to monitor item movement, and self-checkout (SCO) order events to distinguish between scanned and unscanned items. Additionally, the POS system can include predefined static POS subregions (e.g., bagging area, scanner, container) within the camera’s field of view for accurate spatial tracking and a business logic framework can be applied to manage the parallel tracking of multiple items. The POS system can operate on a single edge device equipped with neural computing capabilities, reducing the need for additional cameras or sensors.

In one exemplary embodiment, a POS system or an optical sensor device can obtain data that represents a set of successive images of the POS region captured by the optical sensor device (e.g., camera) as first and second target objects (e.g., retail items) are moved in the POS region. For instance, the POS system or the optical sensor device can receive, from an optical sensor of the optical sensor device, the successive image data. The POS region can include a set of POS subregions such as a POS subregion associated with a container (e.g., basket, shopping cart, shopping bag), a POS subregion associated with an optical scanner device such as a scanner scale device having a scanning window, a POS subregion associated with a bagging area, or the like. The POS system or the optical sensor device can determine, for the set of successive images, the set of successive object locations of each target object in the POS region based on the successive image data. For example, each successive object location can correspond to one of the set of successive images. In another example, each successive object location can correspond to every other successive image or some other integer multiple of successive images. The POS system or the optical sensor device can determine each object movement track based on the set of successive object locations of the corresponding target object.

In the current embodiment, the POS system or the optical sensor device can identify at least one of the set of POS subregions that corresponds to each movement track of the corresponding target object. For instance, the POS system or the optical sensor device can detect, based on the successive image data and the set of POS subregions, activity in at least one of the set of POS subregions. Further, the POS system or the optical sensor device can determine that the activity in the at least one of the set of POS subregions corresponds to a certain target object based on the successive image data and the set of POS subregions. In addition, the POS system or the optical sensor device can determine that the certain target object started or ended in one of the set of POS subregions based on the corresponding object movement track and the set of POS subregions. The POS system or the optical sensor device can receive, from the optical scanner, an indication associated with a scan of the visual object identifier code (e.g., SKU, QR code) disposed on an object (e.g., retail item). In response, the POS system or the optical sensor device can determine that the first target object is transferred to the POS subregion associated with the bagging area without being scanned while the second target object is contemporaneously scanned without being transferred to the POS subregion associated with the bagging area based on a set of predetermined criteria associated with the set of POS subregions, a first object movement track associated with the first target object and a second object movement track associated with the second target object.

In another embodiment, the POS system or the optical sensor device can receive, by a processing circuitry, from the optical scanner, an indication associated with a scan of the visual object identifier code disposed on an object. In response, the POS system or the optical sensor device can determine that the second target object is scanned responsive to determining that the first object movement track of the first target object does not correspond to the POS subregion associated with the scanning window and determining that the second object movement track of the second target object does correspond to the POS subregion associated with the scanning window.

In another embodiment, the POS system or the optical sensor device can receive, by a processing circuitry, from the optical scanner, an indication associated with a scan of the visual object identifier code disposed on an object. In response, the POS system or the optical sensor device can determine an object distance between each target object and the POS subregion associated with the scanning window based on the corresponding object movement track and the POS subregion associated with the scanning window. Further, the POS system or the optical sensor device can determine that the second target object is scanned response to determining that the second target object is closest to the POS subregion associated with the scanning window based on the object distances of the first and second target objects.

In another embodiment, the POS system or the optical sensor device can receive, by a processing circuitry, from the optical scanner, an indication associated with a scan of the visual object identifier code disposed on an object. In response, the POS system or the optical sensor device can identify those of the set of target objects that have a corresponding object movement track that intersects with the POS subregion associated with the scan platform to obtain a set of identified target objects. The POS system or the optical sensor device can determine an object distance between each identified target object and the POS subregion associated with the scanning window based on the corresponding object movement track and the POS subregion associated with the scanning window. Further, the POS system or the optical sensor device can determine that one of the set of identified target objects is scanned responsive to determining that that identified target object is closest to the POS subregion associated with the scanning window based on the object distances of the set of identified target objects.

In various embodiments, a POS system can monitor self-checkout and camera vision-based checkout environments to detect situations in which a customer leaves with one or more items for which payment has not been completed. The system can combine image-based tracking of customers and items with transaction and payment data from POS infrastructure so that potential non-payment events can be detected in real time and surfaced to store personnel. By correlating what appears in image data with what appears in POS records, the POS system can reduce instances of “walk-off” theft and can help ensure that items leaving a retail location have been properly paid for.

A retail environment can include one or more self-checkout stations, which can include conventional barcode scanning self-checkout, camera vision-based checkout, or hybrid configurations. Each self-checkout station can include a terminal portion where items can be scanned or recognized during checkout, and a bagging portion where items can be placed after scanning or recognition. One or more exit paths can extend away from the self-checkout area, and customers can use these exit paths to leave the area and proceed toward store exits. A camera system can obtain successive image data that covers at least a portion of each self-checkout station and the associated exit paths.

At least one processing component, which can reside locally at the store, at an edge device, at a centralized server, or in a cloud environment, can receive the successive image data and can perform analysis to detect locations and movement paths of one or more customers and locations and movement paths of one or more items handled by those customers. The processing component can further correlate the detected customers and items with transaction and payment data obtained from one or more POS devices. In this way, the processing component can determine when a particular customer appears to be moving toward or through an exit path while apparently possessing one or more items that do not correspond to fully paid entries in an associated transaction.

The camera system can include one or more optical sensors configured to capture successive images at a suitable frame rate. The optical sensors can be mounted overhead, integrated into self-checkout structures, positioned on walls or fixtures, or deployed in other configurations that provide coverage of relevant regions. Using the successive images, the processing component can apply computer vision techniques to detect individual persons in the self-checkout region and can assign a persistent identifier to each detected person for a duration of a monitoring session. For each detected person, the processing component can generate customer location data that represents a sequence of customer locations over time, and can derive a corresponding customer location track that represents a movement path of that customer through the self-checkout region.

In parallel, the processing component can detect one or more items that appear in the successive image data and can associate those items with customers and with different areas of the self-checkout region. Item detection can rely on object detection models, motion analysis, segmentation of image regions, or combinations of such techniques. For each detected item, the processing component can derive a sequence of item locations over time and can construct a corresponding item movement track. The self-checkout region can be partitioned into logical subregions, such as a subregion associated with a scanning or recognition area, a subregion associated with a bagging or staging area, one or more subregions associated with a cart or basket area, and one or more subregions associated with exit paths. The processing component can associate segments of each customer location track and each item movement track with these logical subregions.

To determine whether an item appears to be in a customer’s possession, the processing component can define a possession region around the customer location track. The possession region can extend outward from the customer’s apparent body location by a configurable distance and can encompass locations associated with the customer’s hands, arms, carried baskets or bags, carts, or other personal conveyances. When an item movement track enters and remains within the possession region for at least a threshold duration, the processing component can treat that item as being associated with that customer and can update metadata for the item movement track to reflect that association. For instance, when an item appears to be located in a cart or basket being pushed by the customer, the item movement track can be tagged as belonging to the customer’s possession region.

Each self-checkout station can maintain transaction data for an in progress transaction. The transaction data can include one or more item entries corresponding to items that have been scanned or recognized for that transaction, along with associated barcodes, stock keeping unit identifiers, quantities, and prices. The transaction data can also include timestamps for item entries and an overall transaction state (e.g., open, payment initiated, payment completed, cancelled, timed-out). A payment component associated with the self-checkout station can provide payment state information indicating whether a payment flow has been started, which payment method has been selected, whether authorization has been attempted, and whether payment for a total transaction amount has been successfully completed.

The processing component can correlate image-based analysis with transaction and payment data to determine whether items that appear in a customer’s possession region correspond to properly registered and paid items. The processing component can determine which self-checkout station a customer primarily interacts with (e.g., based on spatial proximity and dwell time near a particular terminal or bagging area) and can associate that customer with the transaction active at that station. For each item associated with the customer’s possession region, the processing component can evaluate whether the transaction data includes a corresponding item entry. Correlation can rely on temporal alignment between an item movement track and item registration timestamps in the transaction data, spatial alignment between an item’s movement through a scanning or recognition area and scan events recorded by the station, or visual similarity between the tracked item and item definitions used by a camera vision-based recognition module.

If an item associated with a customer’s possession region does not correspond to any entry in the transaction data, the processing component can treat that item as unregistered. If an item does correspond to an item entry in the transaction data, the processing component can further evaluate the payment state information to determine whether payment for the associated transaction has been completed. For instance, the processing component can treat a transaction as unpaid when payment state information indicates that payment has not been initiated, or when payment has been initiated but not successfully completed.

The processing component can treat a potential non-payment event as occurring when a combination of conditions arises. In one example, the processing component can determine that a potential non-payment event occurs when a customer location track includes at least one location in an exit-related portion of the monitored region while at least one item movement track associated with that customer remains within the possession region, and when, for that item, either no corresponding item entry exists in the transaction data or a corresponding item entry exists but payment for the transaction has not been completed. In some implementations, the processing component may further require that the customer location track include at least one location in a terminal-related portion or a bagging-related portion of the monitored region before entering the exit-related portion, so that customers merely passing near the region without engaging in checkout activity generate fewer alerts.

The processing component may additionally evaluate behavioral patterns when determining whether to classify a situation as a potential non-payment event. For example, the processing component may detect that a customer repeatedly removes items from a cart, moves those items directly toward an exit path without passing through a scanning or bagging area, and does not initiate payment within a configured time window. In another example, the processing component may detect that a customer scans a subset of items, places those items in a staging or bagging location, then retrieves additional items from a cart or shelf and moves toward the exit path without scanning those additional items. The processing component can compute a confidence value for a potential non-payment event based on such behavioral patterns and can apply different alert thresholds depending on store policies.

When the processing component determines that a potential non-payment event occurs or that a confidence value exceeds a threshold, the processing component can generate alert data. The alert data can include one or more images or a short video segment depicting the customer and the associated items near the exit path, an identifier for the associated self-checkout station, transaction metadata including a transaction identifier and current transaction state, and textual or structured information describing a discrepancy, such as a count of items in the possession region that lack transaction entries or a count of items associated with an unpaid transaction. The processing component can embed the alert data in an indication message and can send the indication message over a communication network to one or more associate devices.

An associate network node device can comprise a handheld terminal, a tablet, a workstation, or a specialized alert console. The associate device can receive the indication message and can extract the alert data. A user interface of the associate device can present the alert data to store personnel in real time or near real time. For instance, the associate device can display a thumbnail or full-screen image showing the customer near the exit path, can overlay markers highlighting items believed to be unpaid, and can present transaction and payment status information. The user interface may provide options for an associate to acknowledge the alert, request additional images or video segments, mark the event as resolved or dismissed, or input notes describing what occurred.

The POS system may support multiple alert levels or categories. A first alert level can correspond to early indicators of potential non-payment, such as a customer moving toward an exit path with items in the possession region while transaction data indicate that payment has not yet been initiated. A second alert level can correspond to more definitive conditions, such as a customer crossing a threshold position near the exit with items in the possession region while transaction data indicate that payment has not been completed. The processing component can generate separate records for different alert levels and may route those alerts to different associate devices or roles depending on configuration.

The POS system can support various types of checkout configurations. In a conventional barcode-based self-checkout configuration, scan events can populate the transaction data when a barcode scanner detects a visual identifier associated with an item. In a camera vision-based configuration, item recognition can occur primarily through image analysis, and transaction data can be populated when a camera vision module or device recognizes items within specific regions of the self-checkout station. The correlation logic can adapt to these configurations by matching tracked items to barcode scan events, to camera-vision recognition events, or to a combination of both.

The processing component may employ machine learning models to improve detection of customers and items, determination of possession regions, and classification of behavioral patterns. Training data can include historical video, transaction logs, and prior loss prevention incidents. The POS system may update model parameters over time based on feedback from associates, such as indications that particular alerts corresponded to genuine non-payment events or to false positives. The system can also store event records associated with potential non-payment events, including timestamps, station identifiers, transaction identifiers, summarized movement and possession information, and representative image data. These records can support later auditing, staff training, and analytics for loss-prevention strategies.

Through these combined techniques, the POS system can provide a mechanism for monitoring self-checkout and camera vision-based checkout environments, can identify when a customer appears to leave with items that lack corresponding paid transaction entries, and can support timely intervention by store personnel. This approach can reduce losses associated with walk-off events and can improve overall control and visibility over self-checkout operations in retail environments.

FIG. 1B illustrates one embodiment of a POS system 100b operable to identify an item that bypasses a checkout transaction in accordance with various aspects as described herein. In FIG. 1B, the POS system 100b can operate in conjunction with one or more optical sensor devices 117a-c, a network 150, a network node device 160, and a store associate network node device 190 to detect potential non-payment events during a checkout session. The POS system device 100b can include the terminal station apparatus 102 and the bagging station apparatus 141 having the bagging area 143. The payment terminal bcan be mounted to, or otherwise integrated with, terminal station apparatus 102. One or more optical sensor devices 117a-c can be positioned so that their respective optical fields of view include at least a region about POS system device 100b, referred to as POS region 182. POS region 182 can be partitioned into a set of POS subregions 185a-j, which can include a subregion associated with terminal station apparatus 102, a subregion associated with bagging area 143, one or more subregions associated with carts or baskets proximate POS system device 100b, and an exit-related POS subregion 185j associated with an exit region of POS region 182.

During operation for a given transaction, POS system device 100b can obtain successive image data of POS region 182 from optical sensor devices 117a-c. For instance, any or all of the optical sensor device 117a-c can provide image frames to POS system device 100b or to network node device 160 via network 150. In some implementations, POS system device 100b can perform at least a portion of the image analysis locally, and in other implementations POS system device 100b can send at least a portion of the image data to network node device 160 for preprocessing or inference and can receive processed results in return. As successive images of POS region 182 are obtained, POS system device 100b (alone or in cooperation with network node device 160) can detect a customer 171 and one or more target objects 151 within POS region 182.

POS system device 100b can determine, for each successive image of the successive image data, a customer location associated with customer 171 within POS region 182. From these customer locations, POS system device 100b can construct customer location data representing a set of successive locations of customer 171 and can determine a customer location track that describes a path of customer 171 relative to terminal station apparatus 102, bagging station apparatus 141, and exit-related POS subregion 185j. In parallel, POS system device 100b can detect one or more target objects 151 and can determine, for each target object 151, a corresponding sequence of object locations over time. From these sequences, POS system device 100b can determine an object movement track for each target object 151, including whether an object 151 moves near a scanner window 115 of terminal station apparatus 102, is placed in bagging area 143, remains in a cart or basket proximate POS system device 100b, or moves toward exit-related POS subregion 185j.

POS system device 100b can correlate customer and object locations with POS subregions 185a-j. For each time step, POS system device 100b can determine which POS subregion 185a-j contains the current customer location of customer 171 and which POS subregion 185a-j contains each target object 151. Using this information, POS system device 100b can determine that the customer location track for customer 171 includes at least one customer location in the POS subregion associated with terminal station apparatus 102 and/or the POS subregion associated with bagging area 143, indicating that customer 171 interacted with terminal station apparatus 102 or bagging station apparatus 141 prior to approaching the exit area. POS system device 100b can further determine that the customer location track includes at least one customer location associated with exit-related POS subregion 185j, indicating that customer 171 is approaching or entering an exit region of POS region 182.

To determine whether one or more target objects 151 are in the possession of customer 171 as customer 171 moves toward exit-related POS subregion 185j, POS system device 100b can define a possession region associated with the customer location track. The possession region can be defined by a threshold distance around one or more customer locations along the customer location track and can include particular zones associated with a cart, a basket, or hand regions 151f, 151g of customer 171. For instance, POS system device 100b can determine that a target object 151 is located within the possession region when the corresponding object location is within a threshold distance of at least one customer location of the customer location track or when object 151 is located in a cart or basket proximate customer 171 or in a hand region 151f, 151g of customer 171. When an object movement track for a given object 151 enters and persists within this possession region while the customer location track includes one or more customer locations in exit-related POS subregion 185j, POS system device 100b can identify that object 151 is located within the possession region associated with the customer location track near the exit. In parallel with image-based analysis, POS system device 100b can maintain and access transaction data for a checkout transaction. POS transaction logic of POS system device 100b can maintain one or more item entries that correspond to retail items 151 registered in the checkout transaction, including bar codes scanned via scanner window 115 or via a handheld scanner 116.

In some embodiments, the POS transaction logic can refer to one or more software, firmware, or hardware components associated with a POS system device 100 that manage a lifecycle of a retail checkout transaction. The POS transaction logic can coordinate creation, maintenance, and completion of a transaction and can provide transaction-related data to other components, such as image analysis modules, payment terminal 122, and one or more back office or store controller systems coupled over network 150. The POS transaction logic can cooperate with input devices of POS system device 100 (e.g., scanner window 115, handheld scanner 116, a user interface on display 118) and can act as an authoritative source for transaction state information used by other modules in the system.

The POS transaction logic can maintain transaction data for an in progress checkout transaction. The transaction data can include a transaction identifier, a plurality of item entries corresponding to retail items 151 registered in the transaction, and one or more transaction-level attributes. Each item entry can include, for instance, an item identifier such as a UPC, SKU, PLU, or internal product code, a quantity and unit of measure, a unit price and extended price, taxability and applied tax amounts, identifiers and amounts of applicable discounts or promotions, and one or more timestamps associated with when the item was registered, modified, or voided. Each item entry can further include metadata that identifies a registration mechanism, for instance, whether the item was registered via scanner window 115, via handheld scanner 116, via manual key entry, or via a camera vision recognition event. The transaction-level attributes maintained by the POS transaction logic can include identifiers for a store, lane, and terminal station apparatus 102, a mode indicator such as self-checkout versus cashier assisted, a customer identifier or loyalty account when available, a subtotal, tax total, discount totals, and an overall transaction total, as well as tender information such as tender types (e.g., cash, card, gift card, mobile wallet) and tender amounts. The POS transaction logic can also associate a transaction state with each transaction, where the transaction state can indicate, by way of non-limiting example, that a transaction is open for item entry, that a payment flow has been initiated or is pending, that payment has been approved or declined, or that a transaction has been completed, cancelled, or suspended.

The POS transaction logic can manage state transitions of a transaction as item entries are created, modified, or removed and as payment flows are initiated and finalized. For instance, when a customer 171 begins a checkout session at POS system device 100, the POS transaction logic can create a new transaction record, assign a transaction identifier, and set an initial state such as “transaction-open.” When retail items 151 are scanned at scanner window 115 or via handheld scanner 116, the POS transaction logic can receive scan events, look up associated item records in a product database, determine prices and tax information, create corresponding item entries in the transaction data, and update running totals. When an item is voided by the customer 171 or by an attendant, the POS transaction logic can mark the corresponding item entry as void and adjust transaction totals accordingly. When a customer 171 indicates that checkout should proceed to payment, the POS transaction logic can compute a final amount due and update the transaction state to reflect that a payment flow has been initiated.

In some implementations, the POS transaction logic can also interact with a camera vision-based recognition subsystem coupled to POS region 182. Instead of, or in addition to, receiving barcode scan events, the POS transaction logic can receive item identification events that are generated when a vision subsystem determines that a particular retail item 151 has been recognized within a designated POS subregion 185a-i, such as a scanning subregion near terminal station apparatus 102 or a recognition subregion in bagging area 143 of bagging station apparatus 141. For each such event, the POS transaction logic can create or update an item entry in the transaction data, using a product identifier supplied by the vision subsystem and applying appropriate pricing, tax, and discount rules. The POS transaction logic can further accept corrections provided by an attendant or by the customer 171 (e.g., voiding a misrecognized item 151, substituting a different product code, applying a manual price override) and can record those corrections as part of the transaction history.

The POS transaction logic can cooperate with payment terminal 122 to manage payment flows. When customer 171 elects to pay, the POS transaction logic can compute a total amount due, including taxes and discounts, and can send payment request information to payment terminal 122 (e.g., the amount to be charged, a currency code, a transaction identifier). Payment terminal 122 can then conduct a payment interaction with customer 171 (e.g., by reading a payment card, receiving contactless credentials, accepting a digital wallet token). Throughout this interaction, payment terminal 122 can send payment state information back to the POS transaction logic, indicating that payment has been initiated, that payment authorization is in progress, that authorization has been approved or declined, or that the payment interaction has been cancelled or has timed out. The POS transaction logic can update the transaction state based on these payment state messages, so that the transaction data reflects whether payment remains pending, has been successfully completed, or has failed. After successful payment, the POS transaction logic can finalize the transaction record, trigger printing of a receipt via printer 124 or electronic delivery of a receipt, and set the transaction state to a completed state.

In the context of the camera-based non-payment detection, the POS transaction logic can provide transaction data and transaction state information that a vision-based analysis module uses to verify whether objects 151 in a possession region associated with a customer location track have been properly registered and paid. When the image analysis logic determines, based on successive images captured by optical sensor devices 117a-c, that a particular retail item 151 has traversed a scanning subregion and subsequently appears in bagging area 143, the image analysis logic can request transaction data from the POS transaction logic for a time window around that movement event. If the POS transaction logic reports a matching item entry, and if the transaction state later indicates that payment has been completed, the system can treat that item 151 as properly paid. Conversely, if the POS transaction logic indicates that no item entry exists for item 151 or that the associated transaction remains in a state such as “transaction-open,” “payment-initiated,” or “payment-pending” while the customer 171 moves through exit-related POS subregion 185j with item 151 in a possession region, the system can treat this discrepancy as a potential non-payment condition.

The POS transaction logic can also support auxiliary operations that enhance flexibility of the checkout experience. By way of example, the POS transaction logic can start new transactions when sessions begin, suspend transactions and later resume them at the same or a different terminal station apparatus 102, apply promotions, coupons, and loyalty discounts, handle tax-exempt transactions, and manage age-restricted items that may require attendant approval. The POS transaction logic can record these operations, including approval events and overrides, as part of a transaction event history, which can be stored in a store controller or back-office system for reconciliation, reporting, and compliance purposes.

In some configurations, the POS transaction logic can be distributed across POS system device 100 and a backend network node device 160. A local component of the POS transaction logic on POS system device 100 can handle immediate terminal interactions (e.g., item entry, UI updates, latency-sensitive calculations) while a backend component of the POS transaction logic on network node device 160 can aggregate transaction data across multiple lanes, enforce store-wide pricing and promotion rules, and replicate finalized transaction records to a central server or cloud service over network 150. In such implementations, POS system device 100 can maintain a local view of the transaction state and periodically synchronize that view with network node device 160, so that both local and centralized systems share a consistent representation of item entries, totals, and payment state for each transaction.

Accordingly, POS transaction logic can be understood as transaction management functionality of a POS stack that can maintain a canonical record of each checkout transaction, can expose item-level and transaction-level data and transaction states, and can cooperate with scanning devices, camera vision modules, and payment terminal 122 to enable both conventional POS checkout operations and the camera-based non-payment detection techniques described in connection with POS region 182 and POS subregions 185a-j.

Furthermore, the transaction data can also include a transaction state that indicates whether the transaction remains open, whether payment has been initiated, or whether payment has been completed. Payment terminal 122 can provide payment state information to POS system device 100b indicating whether customer 171 has initiated payment for the transaction (e.g., by presenting a payment card or a mobile wallet) and whether payment for the transaction has been successfully completed. POS system device 100b can obtain the transaction data from the POS transaction logic and the payment state information from payment terminal 122 as part of monitoring the checkout session.

POS system device 100b can verify, for each target object 151 located within the possession region associated with the customer location track, whether that object 151 has a corresponding paid entry in the transaction data. In one implementation, POS system device 100b can determine, based on the corresponding object movement track of target object 151 and the transaction data, whether target object 151 is associated with at least one item entry of the one or more item entries registered in the transaction. This correlation can include a time-based correlation between movements of object 151 into a scanning region proximate scanner window 115 and item registration timestamps in the transaction data, and/or a spatial correlation between object 151 passing through a particular POS subregion 185a-i and scan events associated with that subregion. POS system device 100b can determine that no item entry corresponds to target object 151 when neither the temporal nor spatial criteria match the registered item entries, and can thereby determine that target object 151 lacks a corresponding item entry in the transaction data.

In addition, POS system device 100b can use payment state information from payment terminal 122 to determine whether payment for the transaction has been initiated and whether it has been completed. For instance, POS system device 100b can obtain payment state information indicating that payment for the transaction has been initiated but not completed, such as when customer 171 removes a payment card from payment terminal 122 before authorization completes. POS system device 100b can determine that one or more target objects 151 located within the possession region are associated with item entries in the transaction data while payment for the transaction has not been completed.

When POS system device 100b determines that the customer location track for customer 171 includes at least one customer location in exit-related POS subregion 185j and that at least one target object 151 is located within the possession region associated with the customer location track while either lacking a corresponding item entry in the transaction data or being associated with a transaction for which payment has not been completed, POS system device 100b can classify this situation as a potential non-payment event. In response, POS system device 100b can generate alert data associated with an indication of the potential non-payment event. The alert data can include an identifier of the checkout transaction, an identifier of terminal station apparatus 102, information describing target object(s) 151 (e.g., a product category, estimated size), and one or more images selected from the successive image data that depict customer 171 in exit-related POS subregion 185j with target object(s) 151 located within the possession region.

POS system device 100b can send this alert data over network 150 to one or more downstream devices. In some embodiments, POS system device 100b can send the alert data directly to store associate network node device 190 via network 150. In other embodiments, POS system device 100b can first send an indication containing the alert data to network node device 160, which can perform additional analysis, filtering, or aggregation before forwarding the alert data to store associate network node device 190. Store associate network node device 190 can be operated by a store associate 191 and can present a user interface that displays the alert, including the selected images showing customer 171 near exit-related POS subregion 185j, transaction status information, and a description of the discrepancy between target objects 151 in the possession region and the transaction data.

POS system device 100b can also store, in an associated data store, an event record for each potential non-payment event. The event record can include a representation of the customer location track for customer 171, one or more object movement tracks for relevant target objects 151, the transaction data and payment state information for the associated checkout transaction, and a subset of the successive image data for POS region 182 that corresponds to the time window of the event. In some configurations, POS system device 100b can send this event record or a summary thereof to network node device 160 for centralized storage or later analysis.

In a first example of the operation illustrated in FIG. 1B, customer 171 can approach POS system device 100b with a cart containing several items 151. Customer 171 can scan three items 151 at scanner window 115 of terminal station apparatus 102 and place those scanned items into bagging area 143 of bagging station apparatus 141. POS transaction logic of POS system device 100b can create three item entries in the transaction data for the scanned items. Two additional items 151 can remain in the cart without passing through the scanning subregion associated with scanner window 115. As customer 171 pushes the cart toward exit-related POS subregion 185j, optical sensor devices 117a-c can continue to capture successive images of POS region 182. POS system device 100b can determine that the customer location track for customer 171 includes one or more locations in POS subregions near scanner window 115 and bagging area 143, and later includes one or more locations in exit-related POS subregion 185j. POS system device 100b can further determine that at least one of the remaining items 151 remains within the possession region around customer 171 (e.g., within a cart region associated with customer 171) while that customer location track is in exit-related POS subregion 185j. Transaction data for the associated checkout transaction can show only three registered items, and payment state information from payment terminal 122 can indicate that payment has not yet been initiated. POS system device 100b can determine that one or more target objects 151 lack corresponding item entries and can generate and send alert data via network 150 to store associate network node device 190 for review by store associate 191.

In a second example, customer 171 can scan five items 151 and place them into bagging area 143, thereby creating five item entries in the transaction data. Customer 171 can then initiate payment at payment terminal 122, for instance, by inserting a payment card. Payment state information received by POS system device 100b from payment terminal 122 can indicate that payment has been initiated. If customer 171 cancels payment or removes the card before authorization completes, payment state information can indicate that payment for the transaction has not been completed. When customer bthen picks up the bagged items 151 from bagging area 143, moves through POS region 182, and enters exit-related POS subregion 185j while the items 151 remain in the possession region associated with the customer location track, POS system device 100b can determine that the items 151 correspond to registered item entries in an unpaid transaction. POS system device 100b can classify this as a potential non-payment event, generate alert data that includes a transaction identifier, an unpaid transaction total, and one or more images showing customer 171 with items 151 near exit-related POS subregion 185j, and send the alert data to store associate network node device 190 via network 150.

In a third example, multiple customers 171 can operate in proximity within POS region 182. POS system device 100b can maintain separate customer location tracks and possession regions for each customer 171 and can maintain separate correlations between target objects 151 and transactions associated with different terminal station apparatuses 102. Even when customers 171 pass near each other in POS region 182, POS system device 100b can associate each target object 151 with the appropriate customer 171 based on object movement tracks, possession regions, and interaction with particular POS subregions 185a-j. If one customer 171 completes payment at payment terminal 122 and exits through exit-related POS subregion 185j with only fully paid items 151, POS system device 100b can refrain from generating an alert. If another customer 171 leaves through exit-related POS subregion 185j with one or more items 151 that lack corresponding item entries or belong to an unpaid transaction, POS system device 100b can selectively generate a potential non-payment event for that customer 171 and send alert data to store associate network node device 190. Through this coordinated operation of POS system device 100b, optical sensor devices 117a-c, network 150, network node device 160, and store associate network node device 190, the system illustrated in FIG. 1B can support real-time detection and handling of walk-off and other non-payment scenarios.

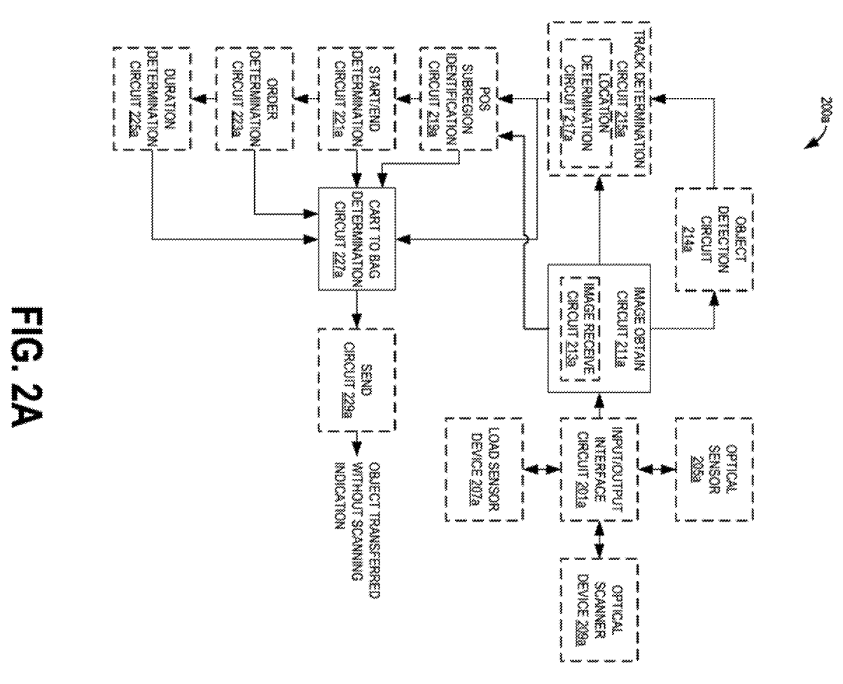

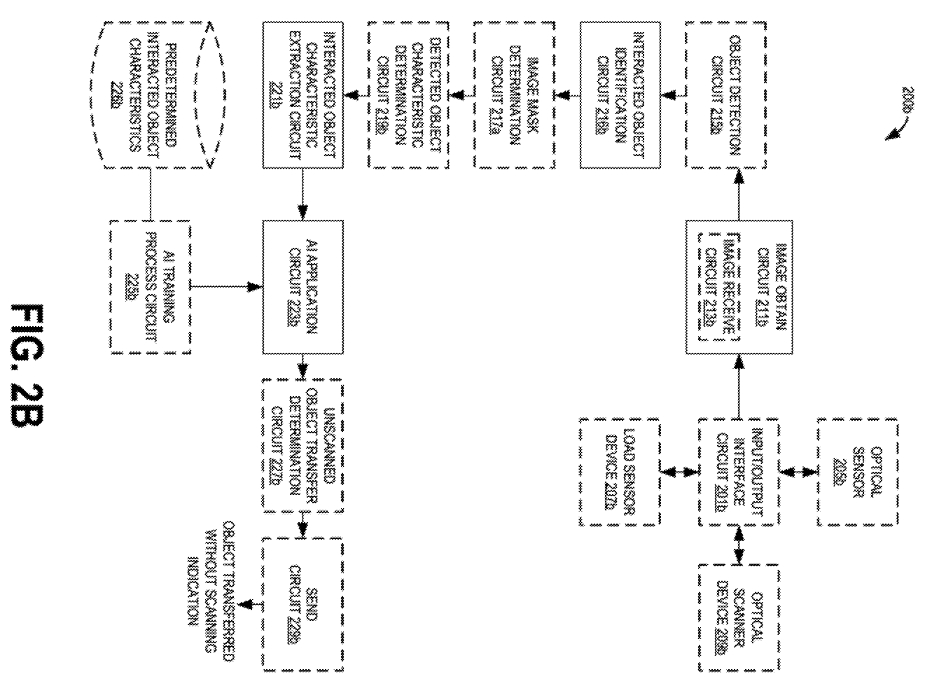

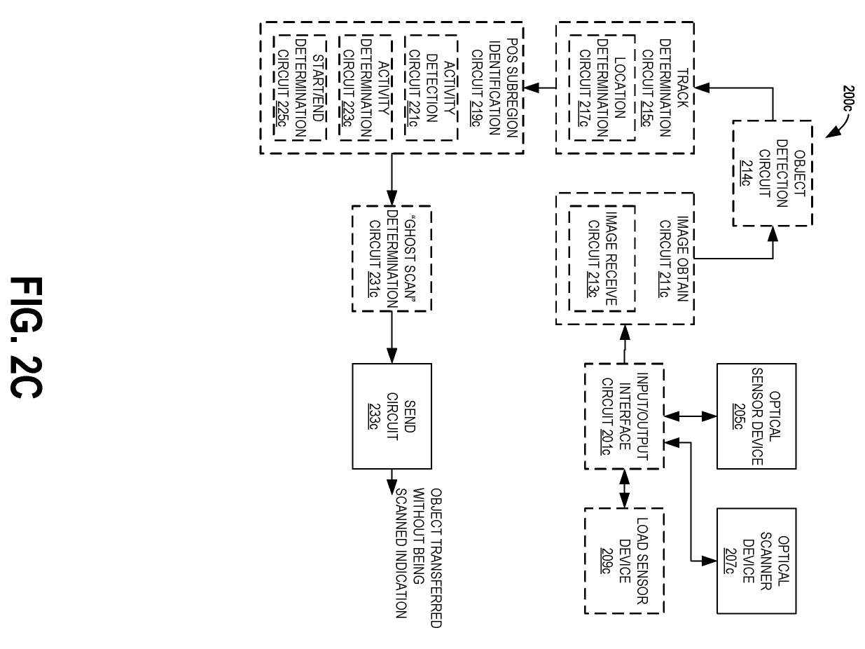

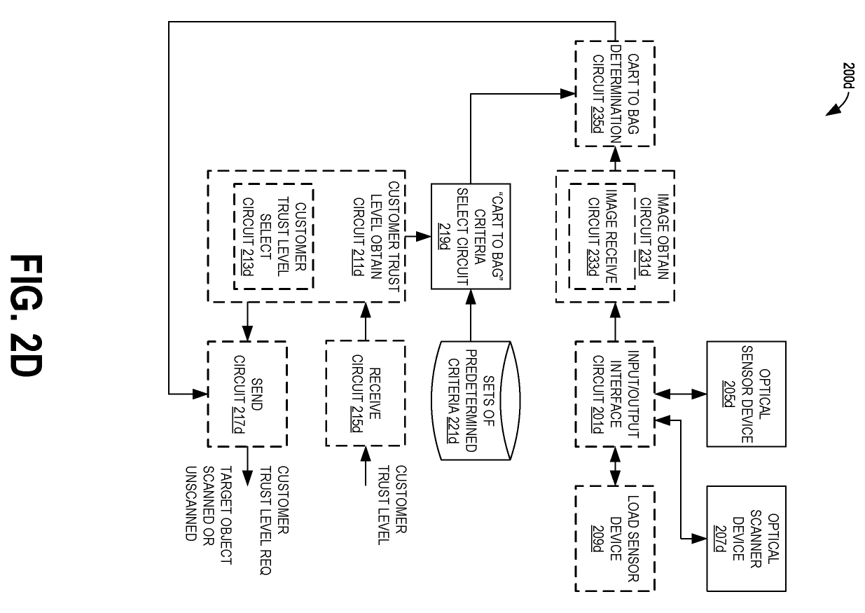

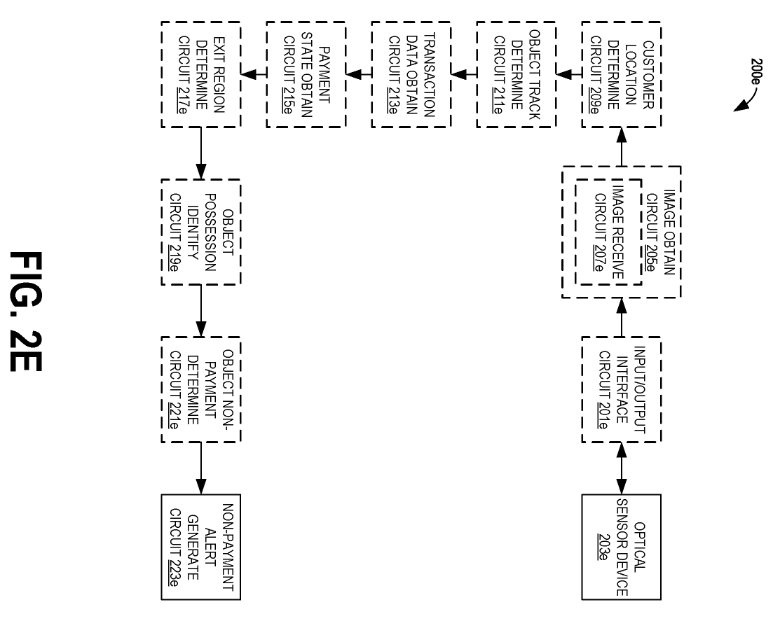

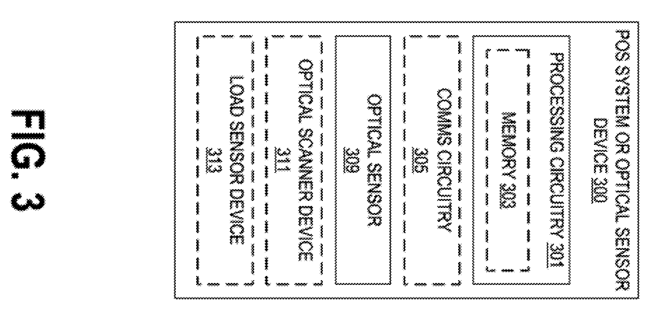

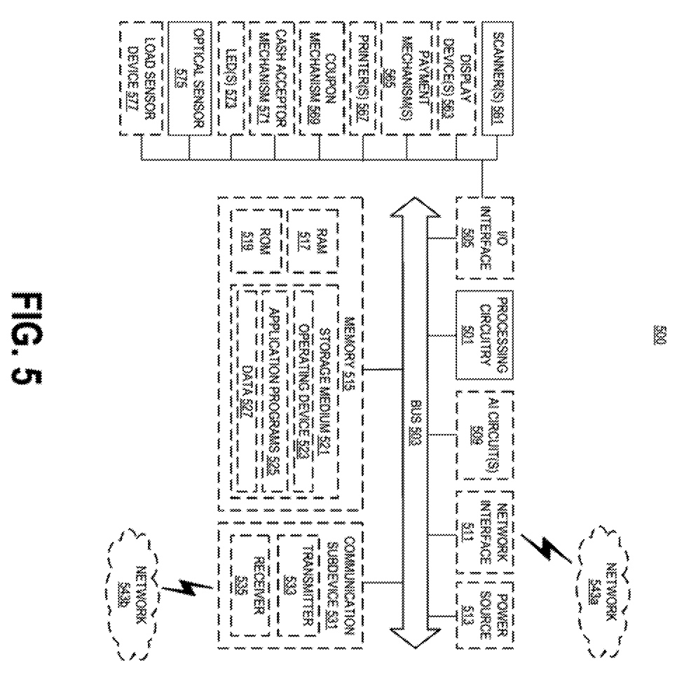

FIG. 2A illustrates another embodiment of a POS system device or an optical sensor device 200a in accordance with various aspects as described herein. In FIG. 2A, the device 200a implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: an input/output interface circuit 201a operable to interface with input and output devices such as an optical sensor or optical sensor device 205a (e.g., camera), a load sensor device 207a (e.g., weight scale), an optical scanner device 209a (e.g., camera, scanner), or the like; an image obtain circuit 211a operable to obtain image data such as from the optical sensor 205a or the optical scanner device 207a; an image receive circuit 213a operable to receive, from the optical sensor 205a or the optical scanner device 207a, an indication that includes successive image data; an object detection circuit 214a operable to detect an object based on the successive image data; a track determination circuit 215a operable to determine an object movement track having a set of successive locations of the target object as the target object is moved in the POS region based on the successive image data; a successive location determination circuit 217a operable to determine, for each successive image, one of the set of successive locations of the target object in the POS region based on the successive image data; a POS subregion identification circuit 219a operable to identify those POS subregions that corresponds to the object movement track of the target object based on the successive image data or the object movement track; a starting/ending POS subregion determination circuit 221a operable to identify a starting or ending POS subregion of the target object based on the successive image data or the object movement track; a POS subregion order determination circuit 223a operable to determine a chronological order of the identified POS subregions based on the successive image data or the object movement track; a duration determination circuit 225a operable to determine a duration between the starting and ending POS subregions that correspond to the object movement track based on the successive image data or the object movement track; a “cart to bag” determination circuit 227a operable to determine that the target object is transferred to the POS subregion associated with the bagging area without being scanned based on the successive image data or the object movement track; and/or a send circuit 229a operable to send information.

FIG. 2B illustrates another embodiment of a POS system device or an optical sensor device 200b in accordance with various aspects as described herein. In FIG. 2B, the device 200b implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: an input/output interface circuit 201b operable to interface with input and output devices such as an optical sensor or optical sensor device 205b (e.g., camera), a load sensor device 207b (e.g., weight scale), an optical scanner device 209b (e.g., camera, scanner), or the like; an image obtain circuit 211b operable to obtain image data such as from the optical sensor 205b or the optical scanner device 207b; an image receive circuit 213b operable to receive, from the optical sensor 205b or the optical scanner device 207b, an indication that includes successive image data; an object detection circuit 215b operable to detect the set of detected objects based on the successive image data; an interacted object identification circuit 216b operable to identify the interacted object from the set of identified objects; an image mask determination circuit 217b operable to determine a set of successive image segmentation masks that visually represents the segmentation of the set of detected objects and the set of POS subregions in the set of successive images based on the successive image data; a detected object characteristic determination circuit 219b operable to determine a set of detected object characteristics based on the set of successive image segmentation masks; an interacted object track characteristic extraction circuit 221b operable to extract, based on the set of detected object characteristics, a set of interacted object track characteristics related to the interacted object from initial detection to last detection of that object in the POS region; an artificial intelligence circuit 223b operable to apply an artificial intelligence model to the set of interacted object characteristics to obtain an indication that the interacted object is transferred to the POS subregion associated with the bagging area without being scanned and a corresponding confidence level; an artificial intelligence training process circuit 225b operable to train the artificial intelligence model based on a set of predetermined interacted object characteristics related to an interacted object from an initial detection to a last detection in the pos region that is proximate the POS subregion associated with the bagging area and without being scanned; an unscanned object transfer determination circuit 227b operable to determine that the interacted object is transferred to the POS subregion associated with the bagging area without being scanned based on the indication and the corresponding confidence level; and/or a send circuit 229b operable to send information.

FIG. 2C illustrates another embodiment of a POS system device or an optical sensor device in accordance with various aspects as described herein. In FIG. 2C, the device 200c implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: an input/output interface circuit 201c operable to interface with input and output devices such as an optical sensor or optical sensor device 205c (e.g., camera), a load sensor device 209c (e.g., weight scale), an optical scanner device 207c (e.g., camera, scanner), or the like; an image obtain circuit 211c operable to obtain image data such as from the optical sensor 205c or the optical scanner device 207c; an image receive circuit 213c operable to receive, from the optical sensor 205c or the optical scanner device 207c, an indication that includes successive image data; an object detection circuit 214c operable to detect an object based on the successive image data; a track determination circuit 215c operable to determine an object movement track having a set of successive locations of each target object as that target object is moved in the POS region based on the successive image data; a successive location determination circuit 217c operable to determine, for each successive image, one of the set of successive locations of the target object in the POS region based on the successive image data; a POS subregion identification circuit 219c operable to identify at least one of the set of POS subregions that corresponds to each movement track of the corresponding target object; an activity detection circuit 221c operable to detect, based on the successive image data, activity in a POS subregion such as a POS subregion associated with a container configured to contain an object, a POS subregion associated with the bagging area, a POS subregion associated with the scanner device, or the like; an activity determination circuit 223c operable to determine that the detected activity in one of the set of POS subregions corresponds to a certain target object; a start/end POS subregion identification circuit 225c operable to determine that a certain target object started or ended in one of the POS subregions based on the corresponding object movement track; a “ghost scan” determination circuit 231c operable to determine that the first target object is transferred to the POS subregion associated with the bagging area without being scanned while the second target object is contemporaneously scanned without being transferred to the POS subregion associated with the bagging area based on a set of predetermined criteria associated with the set of POS subregions, a first object movement track associated with the first target object and a second object movement track associated with the second target object; or a send circuit 233c operable to send information such as an indication associated with a certain target object being transferred to the POS subregion associated with the bagging area without being scanned.

FIG. 2D illustrates another embodiment of a POS system device or an optical sensor device in accordance with various aspects as described herein. In FIG. 2D, the device 200d implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: an input/output interface circuit 201d operable to interface with input and output devices such as an optical sensor or optical sensor device 205d (e.g., camera), an optical scanner device 207d (e.g., camera, scanner), a load sensor device 207d (e.g., weight scale), or the like; a customer trust level obtain circuit 211d operable to obtain one of a set of customer trust levels associated with a customer account that corresponds to a current transaction; a customer trust level select circuit 213d operable to select one of the set of customer trust levels associated with the customer account based on information related to the customer account; a receive circuit 215d operable to receive information; a send circuit 217d operable to send information; a “cart to bag” criteria select circuit 219d operable to select, based on the target customer trust level, one set of sets of predetermined “cart to bag” criteria 221d to enable a determination that the target object of the current transaction is transferred to the POS subregion associated with the bagging area with or without being scanned based on the selected set of predetermined “cart to bag” criteria; an image obtain circuit 231d operable to obtain image data such as from the optical sensor device 205d or the optical scanner device 207d; an image receive circuit 233d operable to receive, from the optical sensor 205d or the optical scanner device 207d, an indication that includes successive image data; or a “cart to bag” determination circuit 235d operable to determine that the target object is transferred to the POS subregion associated with the bagging area with or without being scanned based on the selected set of predetermined “cart to bag” criteria, the set of POS subregions and an object movement track having a set of successive object locations of the target object as the target object is moved in the POS region.

FIG. 2E illustrates another embodiment of a POS system device or an optical sensor device in accordance with various aspects as described herein. In FIG. 2E, the device 200e implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: an input/output interface circuit 201e operable to interface with input and output devices such as an optical sensor or optical sensor device 203d (e.g., camera); a successive image obtain circuitry 205e operable to obtain data that represents a successive image of the POS region captured by the optical sensor device as a customer and one or more target objects are present in the POS region; a successive image receive circuitry 207e operable to receive, from the optical sensor device 203d, an indication that includes a successive image data; a customer location data determine circuitry 209e operable to determine, based on the successive image data, customer location data that represents a set of successive locations associated with the customer present in the POS region, and determining a customer location track based on the customer location data; an object track determine circuitry 211e operable to determine, based on the successive image data, for each target object, a corresponding object movement track in the POS region; a transaction data obtain circuitry 213e operable to obtain, from the POS transaction logic, transaction data associated with the transaction, the transaction data including one or more item entries corresponding to objects registered in the transaction and a transaction state; a payment state information obtain circuitry 215e operable to obtain, from the payment terminal, payment state information associated with the transaction indicative of whether payment for the transaction has been completed; a customer exit region determine circuitry 217e operable to determine, based on the customer location track and the set of POS subregions, that the customer location track includes at least one customer location associated with the POS subregion associated with the exit region; an object possession identify circuitry 219e operable to identify, based on the object movement tracks and the set of POS subregions, that at least one target object is located within a possession region associated with the customer location track while the customer location track includes the at least one customer location associated with the POS subregion associated with the exit region; an object non-payment determine circuitry 221e operable to determine, based on a correlation between the at least one target object located within the possession region associated with the customer location track and the transaction data and the payment state information, that the at least one target object lacks a corresponding item entry in the transaction data or is associated with the transaction while payment for the transaction has not been completed; non-payment alert generate circuitry 223e operable to responsive to determining that the at least one target object located within the possession region associated with the customer location track lacks the corresponding item entry in the transaction data or that payment for the transaction has not been completed, generate an indication of a potential non-payment event associated with the customer; or the like.

FIG. 3 illustrates another embodiment of a POS system/device or an optical sensor device 300 in accordance with various aspects as described herein. In FIG. 3, the device 300 may include processing circuitry 301 that is operably coupled to one or more of the following: memory 303, network communications circuitry 305, an optical sensor device 309 (e.g., camera), an optical scanner device 311 (e.g., scanner), a load sensor device 313, the like, or any combination thereof. The network communication circuitry 305 is configured to transmit or receive information to or from one or more other devices via any communication technology. The processing circuitry 301 is configured to perform processing described herein, such as by executing instructions stored in memory 303. The processing circuitry 301 in this regard may implement certain functional means, units, or modules. The optical sensor or optical sensor device 309 is operable to capture an image, the optical scanner device 311 is operable to capture a visual object identifier code disposed on an object, and the load sensor device 313 is operable to measure a load of an object.

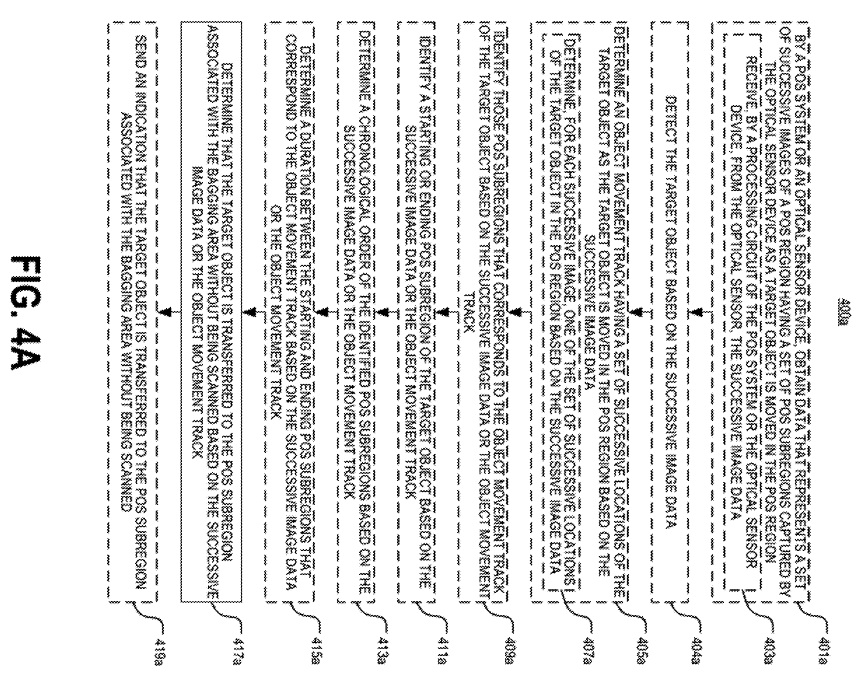

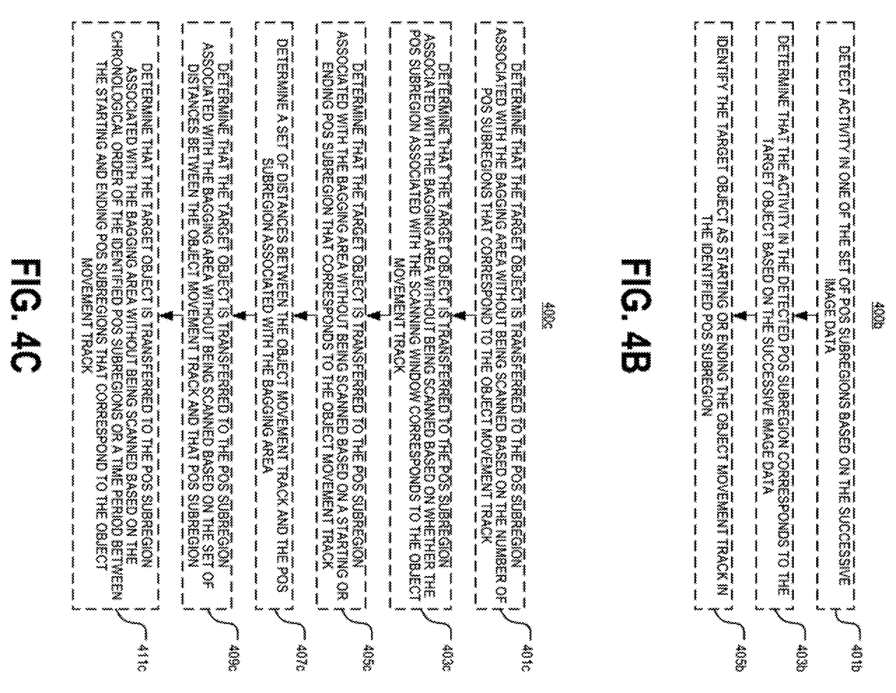

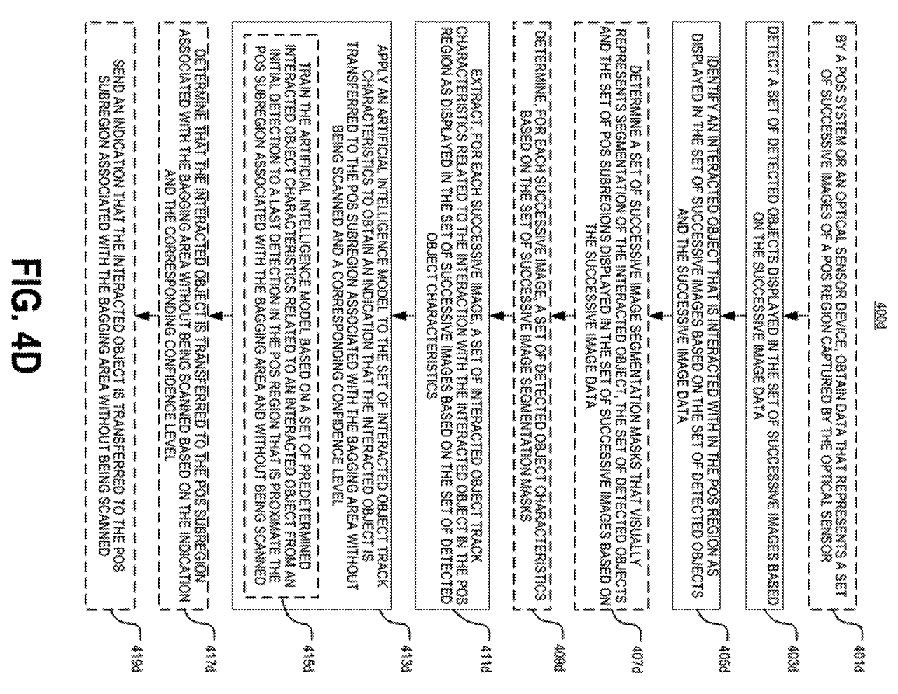

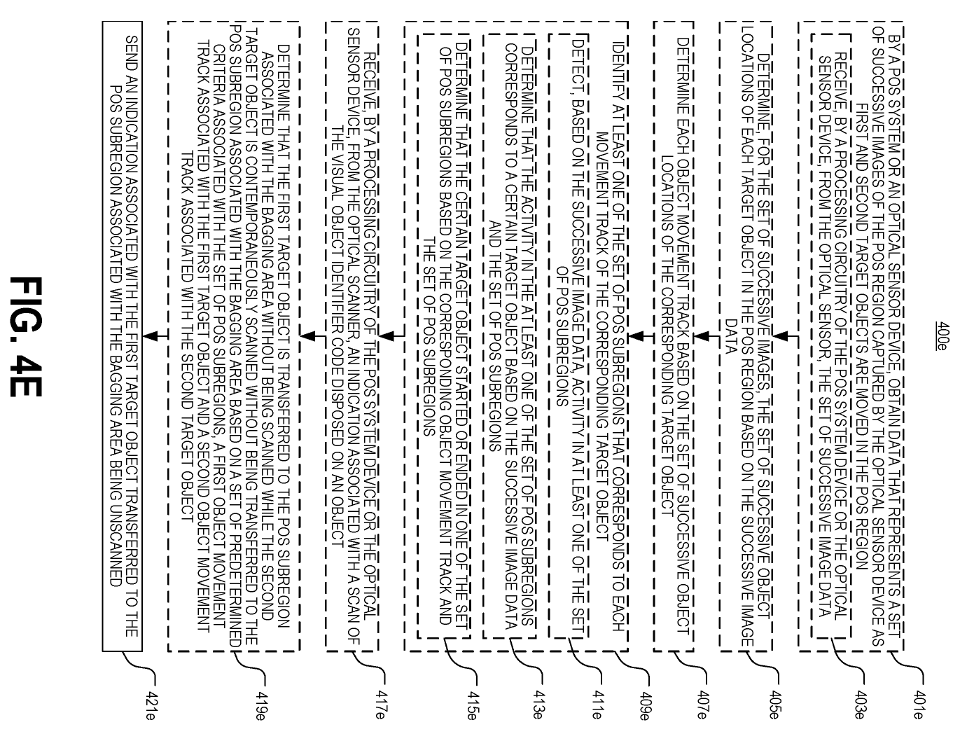

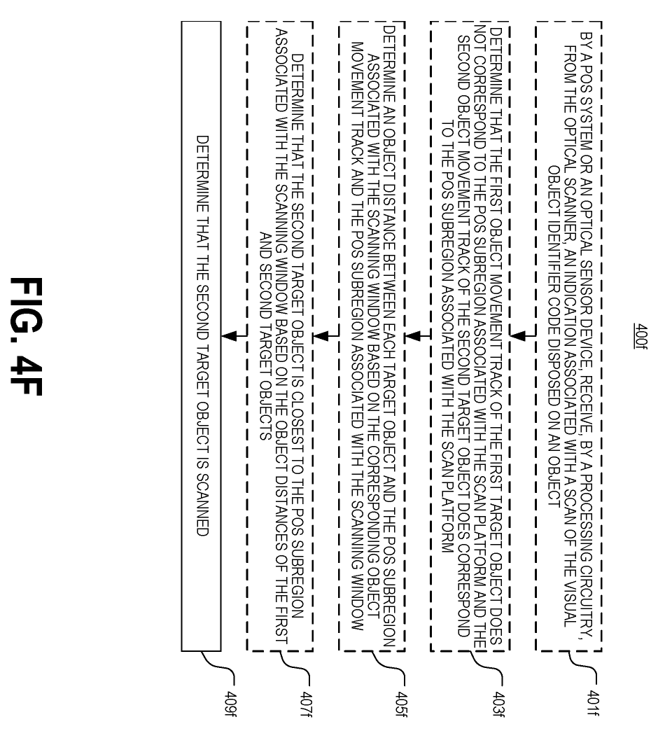

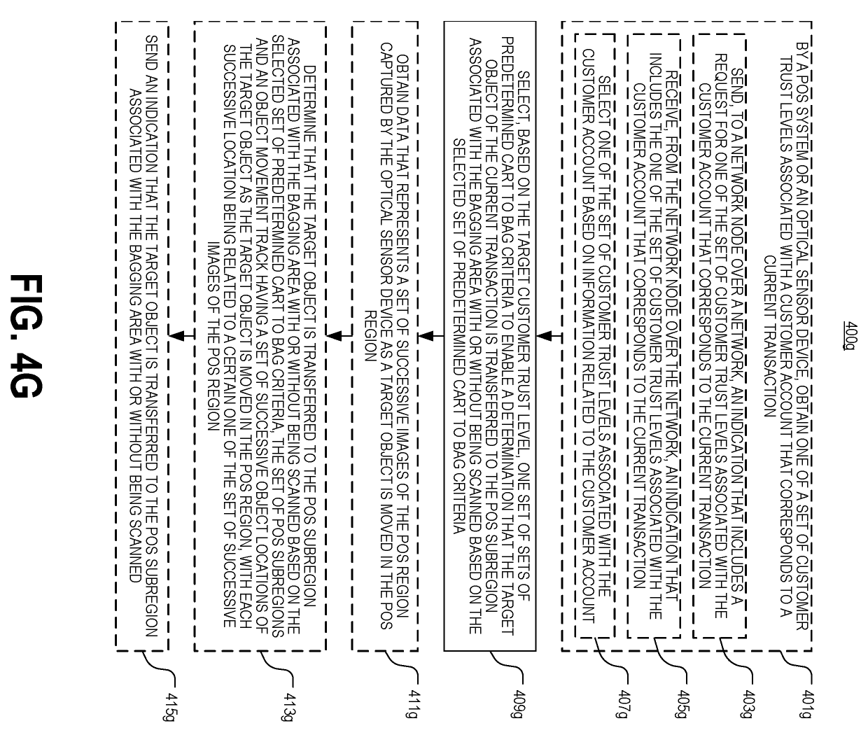

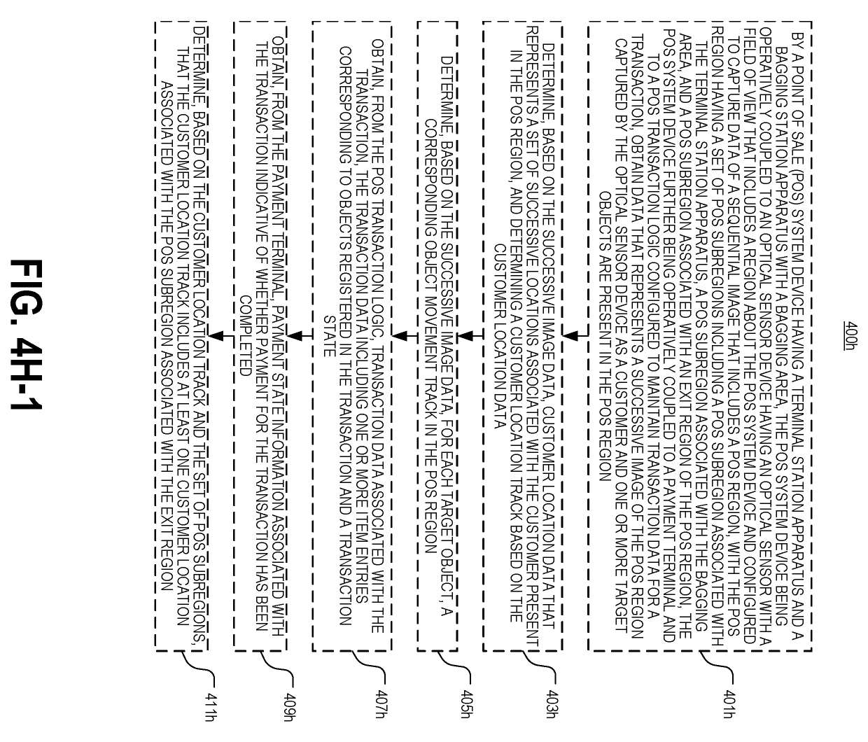

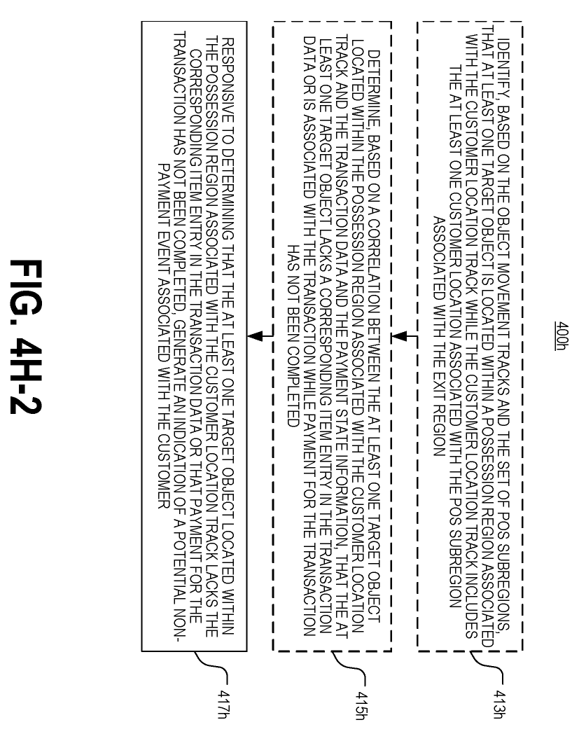

FIG. 4A illustrates one embodiment of a method 400a performed by the POS system 100, 200, 300, 500 or an optical sensor device 117b, 200, 300, 500 of performing item detection at point of sale in accordance with various aspects as described herein. In FIG. 4A, the method 400a may start, for instance, at block 401a where it may include obtaining data that represents a set of successive images of the POS region captured by the optical sensor as a target object is moved in the POS region. For instance, at block 403a, the method 400a may include receiving, by a processing circuit of the POS system 100, 200, 300, 500 or the optical sensor device 117b, 200, 300, 500 from the optical sensor of the optical sensor device 117b, 200, 300, 500 the successive image data. At block 404a, the method 400a can include detecting the target object based on the successive image data. At block 405a, the method 400a may include determining the object movement track having the set of successive locations of the target object as the target object is moved in a POS region based on the successive image data. For instance, the method 400a may include determining, for each successive image, a location of the target object in the POS region based on the corresponding successive image data, as represented by block 407a. At block 409a, the method 400a may include identifying at least one of the set of POS subregions that corresponds to the object movement track of the target object based on the successive image data or the object movement track. The method 400a can also include identifying a starting or ending POS subregion of the target object based on the successive image data or the object movement track, as represented at block 411a. At block 413a, the method 400a can include determining a chronological order of the identified POS subregions based on the successive image data or the object movement track. In addition, at block 415a, the method 400a can include determining a duration between the starting and ending POS subregions that correspond to the object movement track based on the successive image data or the object movement track. At block 417a, the method 400a includes determining that the target object is transferred to the POS subregion associated with the bagging area without being scanned based on the successive image data or the object movement track. At block 419a, the method 400a can include sending an indication that the target object is transferred to the POS subregion associated with the bagging area without being scanned.

FIG. 4B illustrates another embodiment of a method 400b performed by a POS system 100, 200, 300, 500 or an optical sensor device 117b, 200, 300, 500 of performing item detection at point of sale in accordance with various aspects as described herein. In FIG. 4B, the method 400b may start, for instance, at block 401b where it can include detecting activity in one of the set of POS subregions based on the successive image data. At block 403b, the method 400b can include determining that the activity in the detected POS subregion corresponds to the target object based on the successive image data. At block 405b, the method 400b can include identifying the target object as starting or ending the object movement track in the identified POS subregion.

FIG. 4C illustrates another embodiment of a method 400c performed by a POS system 100, 200, 300, 500 or an optical sensor device 117b, 200, 300, 500 of performing item detection at point of sale in accordance with various aspects as described herein. In FIG. 4C, the method 400c may start, for instance, at block 401c where it can include determining that the target object is transferred to the POS subregion associated with the bagging area without being scanned based on the number of POS subregions that correspond to the object movement track. At block 403c, the method 400c can include determining that the target object is transferred to the POS subregion associated with the bagging area without being scanned based on whether the POS subregion associated with the scanning window corresponds to the object movement track. At block 405c, the method 400c can include determining that the target object is transferred to the POS subregion associated with the bagging area without being scanned based on a starting or ending POS subregion that corresponds to the object movement track. The method 400c can include determining a set of distances between the object movement track and the POS subregion associated with the bagging area, as represented by block 407c. In addition, at block 409c, the method 400c can include determining that the target object is transferred to the POS subregion associated with the bagging area without being scanned based on the set of distances between the object movement track and the POS subregion associated with the bagging area. At block 411c, the method 400c can include determining that the target object is transferred to the POS subregion associated with the bagging area without being scanned based on the chronological order of the identified POS subregions or a time period between the starting and ending POS subregions that correspond to the object movement track.

FIG. 4D illustrates one embodiment of a method 400d performed by the POS system 100, 200, 300, 500 or an optical sensor device 117b, 200, 300, 500 of performing item detection at point of sale in accordance with various aspects as described herein. In FIG. 4D, the method 400d may start, for instance, at block 401d where it can include obtaining data that represents a set of successive images of a POS region captured by the optical sensor while at least one of a set of detected objects is interacted with in the POS region. For instance, the method 400d can include receiving, by a processing circuit of the POS system 100, 200, 300, 500 or the optical sensor device 117b, 200, 300, 500 from the optical sensor of the optical sensor device 117b, 200, 300, 500 the successive image data. At block 403d, the method 400d can include detecting a set of detected objects displayed in the set of successive images based on the successive image data. At block 405d, the method 400d includes identifying at least one of the set of detected objects that is interacted with in the POS region based on the successive image data to obtain an interacted object. At block 407d, the method 400d can include determining a set of successive image segmentation masks that visually represents segmentation of the set of detected objects and the set of POS subregions displayed in the set of successive images based on the successive image data. At block 409d, the method 400d can include determining, for each successive image, a set of detected object characteristics based on the set of successive image segmentation masks. At block 411d, the method 400d includes extracting, for each successive image, based on the set of detected object characteristics, a set of interacted object track characteristics related to the interacted object from initial detection to last detection of that object in the POS region. At block 413d, the method 400d includes applying an artificial intelligence model to the set of interacted object characteristics to obtain an indication that the interacted object is transferred to the POS subregion associated with the bagging area without being scanned and a corresponding confidence level. At block 415d, the method 400d can include training the artificial intelligence model based on a set of predetermined interacted object characteristics related to an interacted object from an initial detection to a last detection in the POS region that is proximate the POS subregion associated with the bagging area and/or without being scanned. At block 417d, the method 400d can include determining that the interacted object is transferred to the POS subregion associated with the bagging area without being scanned based on the indication and the corresponding confidence level. At block 419d, the method 400d can include sending an indication that the interacted object is transferred to the POS subregion associated with the bagging area without being scanned.

FIG. 4E illustrates one embodiment of a method 400e performed by a POS system device or an optical sensor device of “ghost scan” detection in accordance with various aspects as described herein. In FIG. 4E, the method 400e can start, for instance, at block 401e where it can include obtaining data that represents a set of successive images of the POS region captured by the optical sensor device as first and second target objects are moved in the POS region. For instance, the method 400e may include receiving, by a processing circuitry of the POS system device or the optical sensor device, from the optical sensor, the successive image data, as represented by block 403e. At block 405e, the method 400e can include determining, for the set of successive images, the set of successive object locations of each target object in the POS region based on the successive image data. At block 407e, the method 400e can include determining each object movement track based on the set of successive object locations of the corresponding target object. At block 409e, the method 400e can include identifying at least one of the set of POS subregions that corresponds to each movement track of the corresponding target object. For instance, the method 400e may include detecting, based on the successive image data, activity in at least one of the set of POS subregions, as represented by block 411e. Further, the method 400e may include determining that the activity in the at least one of the set of POS subregions corresponds to a certain target object based on the successive image data and the set of POS subregions, as represented by block 413e. In addition, the method 400e may include determining that the certain target object started or ended in one of the set of POS subregions based on the corresponding object movement track and the set of POS subregions, as represented by block 415e. At block 417e, the method 400e can include receiving, by a processing circuitry of the POS system device or the optical sensor device, from the optical scanner, an indication associated with a scan of the visual object identifier code disposed on an object. In response, the method 400e can include determining that the first target object is transferred to the POS subregion associated with the bagging area without being scanned while the second target object is contemporaneously scanned without being transferred to the POS subregion associated with the bagging area based on a set of predetermined criteria associated with the set of POS subregions, a first object movement track associated with the first target object and a second object movement track associated with the second target object, as represented by block 417e. Also, each track can include a set of successive object locations of the corresponding target object as that target object is moved in the POS region. At block 421e, the method 400e includes sending an indication associated with the first target object transferred to the POS subregion associated with the bagging area being unscanned.

FIG. 4F illustrates another embodiment of a method 400f performed by a POS system device or an optical sensor device of “ghost scan” detection in accordance with various aspects as described herein. In FIG. 4F, the method 400f may start, for instance, at block 401f where it can include receiving, by a processing circuitry, from the optical scanner, an indication associated with a scan of the visual object identifier code disposed on an object. At block 403f, the method 400f can include determining that the first object movement track of the first target object does not correspond to the POS subregion associated with the scan platform and the second object movement track of the second target object does correspond to the POS subregion associated with the scan platform. At block 405f, the method 400f can include determining an object distance between each target object and the POS subregion associated with the scanning window based on the corresponding object movement track and the POS subregion associated with the scanning window. Further, the method 400f can include determining that the second target object is closest to the POS subregion associated with the scanning window based on the object distances of the first and second target objects, as represented by block 407f. At block 409f, the method 400f includes determining that the second target object is scanned responsive to step 403f or steps 405f, 407f.

FIG. 4G illustrates one embodiment of a method 400g performed by a POS system device or an optical sensor device of “cart to bag” detection with or without scanning in accordance with various aspects as described herein. In FIG. 4G, the method 400g may start, for instance, at block 401g where it can include obtaining one of a set of customer trust levels associated with a customer account that corresponds to a current transaction. At block 403g, the method 400g may include sending, to a network node over a network, an indication that includes a request for one of the set of customer trust levels associated with the customer account that corresponds to the current transaction. In response, the method 400g may include receiving, from the network node over the network, an indication that includes the one of the set of customer trust levels associated with the customer account that corresponds to the current transaction, as represented by block 405g. At block 407g, the method 400g may include selecting one of the set of customer trust levels associated with the customer account based on information related to the customer account. At block 409g, the method 400g includes selecting, based on the target customer trust level, one set of sets of predetermined “cart to bag” criteria to enable a determination that the target object of the current transaction is transferred to the POS subregion associated with the bagging area with or without being scanned based on the selected set of predetermined “cart to bag” criteria. At block 411g, the method 400g can include obtaining data that represents a set of successive images of the POS region captured by the optical sensor device as a target object is moved in the POS region. At block 413g, the method 400g can include determining that the target object is transferred to the POS subregion associated with the bagging area with or without being scanned based on the selected set of predetermined “cart to bag” criteria, the set of POS subregions and an object movement track having a set of successive object locations of the target object as the target object is moved in the POS region. Further, each successive location can be related to a certain one of the set of successive images of the POS region. At block 415g, the method 400g can include sending an indication that the target object is transferred to the POS subregion associated with the bagging area with or without being scanned.

FIGS. 4H-1 and 4H-2 illustrate one embodiment of a method 400h of identifying that an item bypasses a checkout transaction in accordance with various aspects as described herein. In FIG. 4H-1, the method 400h may start, for instance, at block 401h where it can include obtaining data that represents a successive image of the POS region captured by the optical sensor device as a customer and one or more target objects are present in the POS region. At block 403h, the method 400h can include determining, based on the successive image data, customer location data that represents a set of successive locations associated with the customer present in the POS region, and determining a customer location track based on the customer location data. At block 405h, the method 400h can include determining, based on the successive image data, for each target object, a corresponding object movement track in the POS region. At block 407h, the method 400h can include obtaining, from the POS transaction logic, transaction data associated with the transaction, the transaction data including one or more item entries corresponding to objects registered in the transaction and a transaction state. At block 409h, the method 400h can include obtaining, from the payment terminal, payment state information associated with the transaction indicative of whether payment for the transaction has been completed. At block 411h, the method 400hcan include determining, based on the customer location track and the set of POS subregions, that the customer location track includes at least one customer location associated with the POS subregion associated with the exit region.

In FIG. 4H-2, the method 400h can include identifying, based on the object movement tracks and the set of POS subregions, that at least one target object is located within a possession region associated with the customer location track while the customer location track includes the at least one customer location associated with the POS subregion associated with the exit region, as represented by block 413h. At block 415h, the method 400h can include determining, based on a correlation between the at least one target object located within the possession region associated with the customer location track and the transaction data and the payment state information, that the at least one target object lacks a corresponding item entry in the transaction data or is associated with the transaction while payment for the transaction has not been completed. At block 417h, the method 400h can include, responsive to determining that the at least one target object located within the possession region associated with the customer location track lacks the corresponding item entry in the transaction data or that payment for the transaction has not been completed, generating an indication of a potential non-payment event associated with the customer.

FIG. 5 illustrates another embodiment of a POS system device or an optical sensor device (e.g., camera system) 500 in accordance with various aspects as described herein. In FIG. 5, device 500 includes processing circuitry 501 that is operatively coupled over bus 503 to input/output interface 505, artificial intelligence circuitry 509 (e.g., neural network circuit, machine learning circuit), network connection interface 511, power source 513, memory 515 including random access memory (RAM) 517, read-only memory (ROM) 519 and storage medium 521, communication subsystem 531, and/or any other component, or any combination thereof. In one example, the device 500 can be operatively coupled to one or more optical sensor devices over a wired communication interface (e.g., USB, Ethernet) or wireless communication interface (e.g., WiFi, Bluetooth). Further, the device 500 can be operatively coupled to one or more optical sensor devices via the network connection interface 511 or the communication subsystem 531.

The input/output interface 505 may be configured to provide a communication interface to an input device, output device, or input and output device. The device 500 may be configured to use an output device via input/output interface 505. An output device 561 may use the same type of interface port as an input device. For example, a USB port or a Bluetooth port may be used to provide input to and output from the device 500. The output device may be a speaker, a sound card, a video card, a display, a monitor, a printer, an actuator, a transducer 575 (e.g., speaker, ultrasound emitter), an emitter, a smartcard, another output device, or any combination thereof. The device 500 may be configured to use an input device via input/output interface 505 to allow a user to capture information into the device 500. The input device may include a scanner 561 (e.g., optical scanner device), a touch-sensitive or presence-sensitive display 563, an optical sensor 575 (e.g., camera), a load sensor (e.g., weight sensor), a microphone, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, a microphone, an ultrasound sensor, another like sensor, or any combination thereof. As shown in FIG. 5, the input/output interface 505 can be configured to provide a communication interface to components of the POS system 100 such as the scanner associated with the scanner window 115, the scanner 116, a scale associated with the scan platform 114, the display device 118, touchscreen 118, the payment processing mechanism 122, the printer 124, the coupon slot mechanism 125, the cash acceptor mechanism 126, light emitting devices 130, keyboard, keypad, card reader, the like, or any combination thereof.

In FIG. 5, storage medium 521 may include operating system 523, application program 525, data 527, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the artificial intelligence circuitry 509 may be configured to learn to perform tasks by considering examples such as performing detection, classification or identification of objects based on an image. In one example, first artificial intelligence circuitry is configured to perform activity detection. Further, second artificial intelligence circuitry is configured to perform object classification or identification. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Alternatively or additionally, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Additional embodiments will now be described. At least some of these embodiments may be described as applicable in certain contexts for illustrative purposes, but the embodiments are similarly applicable in other contexts not explicitly described.

In one exemplary embodiment, a method is performed by a POS system having a terminal station apparatus and a bagging station apparatus with a bagging area. The terminal station apparatus includes a scanning platform having a scanning window and an optical scanner operable to scan through the scanning window a visual object identifier code disposed on an object while transferred over the scanning window. Further, the POS system is operationally coupled to an optical sensor device having an optical sensor with a field of view that includes a region about the POS system and operable to capture an image that includes the POS region. The POS region includes a set of POS subregions with a first POS subregion associated with a container having one or more objects, a second POS subregion associated with the scanning platform, a third POS subregion disposed in the second POS region and associated with the scanning window, and a fourth POS subregion associated with the bagging area. The method includes obtaining data that represents a set of successive images of the POS region captured by the optical sensor device as a target object is moved in the POS region to enable a determination that the target object is transferred to the fourth POS subregion without being scanned based on a set of criteria associated with the set of POS subregions and an object movement track having a set of successive object locations of the target object as the target object is moved in the POS region. Further, each successive object location is determined based on the corresponding successive image.

In another exemplary embodiment, the image obtaining step can further include receiving, by a processing circuit of the POS system or the optical sensor device, from the optical sensor, the successive image data.

In another exemplary embodiment, the method can further include detecting activity in the first POS subregion based on the successive image data; determining that the activity in the first POS subregion corresponds to the target object disposed in the container based on the successive image data; or identifying the target object as starting the object movement track in the first POS subregion.

In another exemplary embodiment, the method can further include identifying at least one of the set of POS subregions that corresponds to the object movement track of the target object; determining a chronological order of the identified POS subregions; or determining a duration between the starting and ending POS subregions that correspond to the object movement track.

In another exemplary embodiment, the tracked location determining step can further include determining, for the set of successive images, the set of successive object locations of the target object in the POS region based on the successive image data; or determining the object movement track based on the set of successive object locations.

In another exemplary embodiment, the tracked location determination step can further include determining a trajectory of the target object at that location based on the successive image data.

In another exemplary embodiment, the method can further include determining that the target object is transferred to the fourth POS subregion without being scanned based on the set of criteria associated with the set of POS subregions and the object movement track.

In another exemplary embodiment, at least one of the set of criteria is associated with a number of the set of POS subregions that corresponds to the object movement track.

In another exemplary embodiment, at least one of the set of criteria is associated with a starting or ending POS subregion of the set of POS subregions that corresponds to the object movement track.

In another exemplary embodiment, at least one of the set of criteria is associated with a certain one of the set of POS subregions that corresponds to the object movement track.

In one exemplary embodiment, a POS system includes a terminal station apparatus and a bagging station apparatus with a bagging area. The terminal station apparatus includes a scanning platform with a scanning window and an optical scanning device operable to scan through the scanning window a visual object identifier code disposed on an object while transferred over the scanning window. The POS system is operationally coupled to an optical sensor device having an optical sensor with a field of view that includes a region about the POS system and operable to capture an image that includes the POS region. The POS region includes a set of POS subregions with a first POS subregion associated with a container having one or more objects, a second POS subregion associated with the scanning platform, a third POS subregion disposed in the second POS region and associated with the scanning window, and a fourth POS subregion associated with the bagging area. The POS system further includes a memory containing instructions executable by the processing circuitry, whereby the processing circuitry is configured to obtain data that represents a set of successive images of the POS region captured by the optical sensor device as a target object is moved in the POS region to enable a determination that the target object is transferred to the fourth POS subregion without being scanned based on a set of criteria associated with the set of POS subregions and an object movement track having a set of successive object locations of the target object as the target object is moved in the POS region. Further, each successive location is related to a certain one of the set of successive images of the POS region.

In another exemplary embodiment, the memory includes further instructions executable by the processing circuitry whereby the processing circuitry is configured to: detect activity in the first POS subregion based on the successive image data; determine that the activity in the first POS subregion corresponds to the target object disposed in the container based on the successive image data; or identify the target object as starting the object movement track in the first POS subregion.

In another exemplary embodiment, the memory includes further instructions executable by the processing circuitry whereby the processing circuitry is configured to identify at least one of the set of POS subregions that corresponds to object movement track.

In another exemplary embodiment, the memory includes further instructions executable by the processing circuitry whereby the processing circuitry is configured to: detect activity in the POS region based on the successive image; determine that the detected activity in the POS region corresponds to the target object in the second subregion based on the successive image; or determine that the target object can be in the bagging area without having to be scanned or weighed based on the successive image.

In another exemplary embodiment, the memory includes further instructions executable by the processing circuitry whereby the processing circuitry is configured to: determine, for the set of successive images, the set of successive object locations of the target object in the POS region based on the successive image data; or determine the object movement track based on the set of successive object locations.

In another exemplary embodiment, the memory includes further instructions executable by the processing circuitry whereby the processing circuitry is configured to determine that the target object is transferred to the fourth POS subregion without being scanned based on the set of criteria associated with the set of POS subregions and the object movement track.

In one exemplary embodiment, a POS system includes a terminal station apparatus, a bagging station apparatus, and an optical sensor device. The terminal station apparatus has a scanning platform that includes a scanning window and an optical scanner device operable to scan through the scanning window a visual object identifier code disposed on an object while transferred over the scanning window. The bagging station apparatus includes a bagging area. The optical sensor device includes an optical sensor having a field of view that includes a region about the POS system and operable to capture an image that includes the POS region. The POS region includes a set of POS subregions, with a first POS subregion being associated with a container having one or more objects, a second POS subregion being associated with the scanning platform, a third POS subregion disposed in the second POS region and associated with the scanning window, and a fourth POS subregion associated with the bagging area. The POS system further includes a processing circuitry and a memory containing instructions executable by the processing circuitry whereby the processing circuitry is operative to obtain data that represents a set of successive images of the POS region captured by the optical sensor device as a target object is moved in the POS region to enable a determination that the target object is transferred to the fourth POS subregion without being scanned based on a set of criteria associated with the set of POS subregions and an object movement track having a set of successive object locations of the target object as the target object is moved in the POS region. In addition, each successive location is related to a certain one of the set of successive image.

In one exemplary embodiment, a method performed by a POS system having a terminal station apparatus and a bagging station apparatus with a bagging area. Further, the terminal station apparatus includes a scanning platform having a scanning window and an optical scanner operable to scan through the scanning window a visual object identifier code disposed on an object while transferred over the scanning window. The POS system is operationally coupled to an optical sensor device having an optical sensor with a field of view that includes a region about the POS system and operable to capture an image that includes the POS region. The POS region includes a set of POS subregions with a POS subregion associated with a container configured to carry one or more objects, a POS subregion associated with the scanning window, and a POS subregion associated with the bagging area. The method includes identifying an interacted object from a set of detected objects in the POS region based on data that represents a set of successive images of the POS region captured by the optical sensor while the interacted object is interacted with in the POS region; extracting a set of interacted object track characteristics based on a set of detected object characteristics determined from a set of successive image segmentation masks that visually represents a segmentation of the set of detected objects and the set of POS subregions in the set of successive images; and applying an artificial intelligence model to the set of interacted object track characteristics to enable a determination that the interacted object is transferred to the POS subregion associated with the bagging area without being scanned.

In another exemplary embodiment, the method can further include applying the artificial intelligence model to the set of interacted object track characteristics to obtain an indication that the interacted object is transferred to the POS subregion associated with the bagging area without being scanned and a corresponding confidence level; and determining that the interacted object is transferred to the POS subregion associated with the bagging area without being scanned based on the indication and the corresponding confidence level.

In another exemplary embodiment, the method can further include detecting the set of detected objects displayed in the set of successive images based on the successive image data.

In another exemplary embodiment, the method can further include determining a set of successive image segmentation masks that visually represents the segmentation of the set of detected objects and the set of POS subregions displayed in the set of successive images based on the successive image data.

In another exemplary embodiment, the method can further include determining the set of detected object characteristics based on the set of successive image segmentation masks.

In another exemplary embodiment, the method can further include training the artificial intelligence model based on a set of predetermined interacted object track characteristics related to an object interacted with in the POS region from initial detection of that object in the POS region to a last detection of that object in the POS region that is proximate the POS subregion associated with the bagging area and without being scanned.

In another exemplary embodiment, the set of detected object characteristics includes a distance between at least two of the set of detected objects.

In another exemplary embodiment, the set of detected object characteristics includes a distance between at least one of the set of detected objects and at least one of the set of POS subregions.

In another exemplary embodiment, the set of interacted object track characteristics includes a distance between the interacted object and another object that interacts with the interacted object from initial detection of the interacted object in the POS region to a last detection of the interacted object in the POS region.

In another exemplary embodiment, the set of interacted object track characteristics includes a distance between the interacted object and the container from initial detection of the interacted object in the POS region to a last detection of the interacted object in the POS region.

In one exemplary embodiment, a POS system includes a terminal station apparatus and a bagging station apparatus with a bagging area. Further, the terminal station apparatus includes a scanning platform having a scanning window and an optical scanner operable to scan through the scanning window a visual object identifier code disposed on an object while transferred over the scanning window. The POS system is operationally coupled to an optical sensor device having an optical sensor with a field of view that includes a region about the POS system and operable to capture an image that includes the POS region. In addition, the POS region includes a set of POS subregions with a POS subregion associated with a container configured to carry one or more objects, a POS subregion associated with the scanning window, and a POS subregion associated with the bagging area. The POS system further includes processing circuitry and a memory, with the memory containing instructions executable by the processing circuitry whereby the processing circuitry is configured to identify an interacted object from a set of detected objects in the POS region based on data that represents a set of successive images of the POS region captured by the optical sensor while the interacted object is interacted with in the POS region; extract a set of interacted object track characteristics based on a set of detected object characteristics determined from a set of successive image segmentation masks that visually represents a segmentation of the set of detected objects and the set of POS subregions in the set of successive images; and apply an artificial intelligence model to the set of interacted object track characteristics to enable a determination that the interacted object is transferred to the POS subregion associated with the bagging area without being scanned.

In another exemplary embodiment, the memory includes further instructions executable by the processing circuitry whereby the processing circuitry is configured to apply the artificial intelligence model to the set of interacted object track characteristics to obtain an indication that the interacted object is transferred to the POS subregion associated with the bagging area without being scanned and a corresponding confidence level; and determine that the interacted object is transferred to the POS subregion associated with the bagging area without being scanned based on the indication and the corresponding confidence level.

In another exemplary embodiment, the memory includes further instructions executable by the processing circuitry whereby the processing circuitry is configured to detect the set of detected objects displayed in the set of successive images based on the successive image data.

In another exemplary embodiment, the memory includes further instructions executable by the processing circuitry whereby the processing circuitry is configured to determine a set of successive image segmentation masks that visually represents the segmentation of the set of detected objects and the set of POS subregions displayed in the set of successive images based on the successive image data.

In another exemplary embodiment, the memory includes further instructions executable by the processing circuitry whereby the processing circuitry is configured to determine the set of detected object characteristics based on the set of successive image segmentation masks.

In another exemplary embodiment, the memory includes further instructions executable by the processing circuitry whereby the processing circuitry is configured to train the artificial intelligence model based on a set of predetermined interacted object track characteristics related to an object interacted with in the POS region from initial detection of that object in the POS region to a last detection of that object in the POS region that is proximate the POS subregion associated with the bagging area and without being scanned.

In one exemplary embodiment, a POS system includes a terminal station apparatus having a scanning platform that includes a scanning window and an optical scanner device operable to scan through the scanning window a visual object identifier code disposed on an object while transferred over the scanning window; a bagging station apparatus having a bagging area; an optical sensor device having an optical sensor with a field of view that includes a region about the POS system and operable to capture an image that includes the POS region, with the POS region having a set of POS subregions including a POS subregion associated with a container, a POS subregion associated with the scanning window, and a POS subregion associated with the bagging area; and a processing circuitry and a memory containing instructions executable by the processing circuitry whereby the processing circuitry is operative to: identify an interacted object from a set of detected objects in the POS region based on data that represents a set of successive images of the POS region captured by the optical sensor while the interacted object is interacted with in the POS region; extract a set of interacted object track characteristics based on a set of detected object characteristics determined from a set of successive image segmentation masks that visually represents a segmentation of the set of detected objects and the set of POS subregions in the set of successive images; and apply an artificial intelligence model to the set of interacted object track characteristics to enable a determination that the interacted object is transferred to the POS subregion associated with the bagging area without being scanned.

In one exemplary embodiment, a method is performed by a POS system device having a terminal station apparatus and a bagging station apparatus with a bagging area. Further, the terminal station apparatus includes a scanning platform having a scanning window and an optical scanner operable to scan through the scanning window a visual object identifier code disposed on an object while transferred over the scanning window. The POS system device is operationally coupled to an optical sensor device having an optical sensor with a field of view that includes a region about the POS system device and operable to capture an image that includes the POS region. In addition, the POS region includes a set of POS subregions including a POS subregion associated with the scanning window and a POS subregion associated with the bagging area. The method includes obtaining data that represents a set of successive images of the POS region captured by the optical sensor device as first and second target objects are moved in the POS region to enable a determination that the first target object is transferred to the POS subregion associated with the bagging area without being scanned while the second target object is contemporaneously scanned without being transferred to the POS subregion associated with the bagging area based on a set of predetermined criteria associated with the set of POS subregions, a first object movement track associated with the first target object and a second object movement track associated with the second target object. Also, each track includes a set of successive object locations of the corresponding target object as that target object is moved in the POS region.

In another exemplary embodiment, the image obtaining step can further include receiving, by a processing circuitry of the POS system device or the optical sensor device, from the optical sensor, the successive image data.

In another exemplary embodiment, the method can further include determining, for the set of successive images, the set of successive object locations of each target object in the POS region based on the successive image data and determining each object movement track based on the set of successive object locations of the corresponding target object.

In another exemplary embodiment, the method can further include detecting, based on the successive image data, activity in a POS subregion of the set of POS subregions that is associated with a container configured to contain an object and determining that the activity in that POS subregion corresponds to the first or second target object being transferred from or placed in the container based on the successive image data and the POS subregion associated with the container.

In another exemplary embodiment, the method can further include identifying the first or second target object as starting or ending the corresponding object movement track in the POS subregion associated with the container or the bagging area.

In another exemplary embodiment, the method can further include identifying at least one of the set of POS subregions that corresponds to each movement track of the corresponding target object.

In another exemplary embodiment, the method can further include determining, based on the set of predetermined criteria, the first and second object movement tracks and the set of POS subregions, that the first target object is transferred to the POS subregion associated with the bagging area without being scanned while the second target object is contemporaneously scanned without being transferred to the POS subregion associated with the bagging area.

In another exemplary embodiment, the method can further include receiving, by a processing circuitry of the POS system device or the optical sensor device, from the optical scanner, an indication associated with a scan of the visual object identifier code disposed on an object; determining an object distance between each target object and the POS subregion associated with the scanning window based on the corresponding object movement track and the POS subregion associated with the scanning window; and determining that the second target object is scanned responsive to determining that the second target object is closest to the POS subregion associated with the scanning window based on the object distances of the first and second target objects.

In another exemplary embodiment, the method can further include receiving, by a processing circuitry of the POS system device, from the optical scanner, an indication associated with a scan of the visual object identifier code disposed on an object; determining that the second target object is scanned responsive to determining that the first object movement track of the first target object does not correspond to the POS subregion associated with the scanning window and the second object movement track of the second target object does correspond to the POS subregion associated with the scanning window; and sending an indication that the target object is transferred to the POS subregion associated with the bagging area without being scanned.

In another exemplary embodiment, at least one of the set of predetermined criteria is associated with a starting or ending POS subregion of the set of POS subregions that corresponds to an object movement track.

In one exemplary embodiment, a POS system device includes a terminal station apparatus and a bagging station apparatus with a bagging area. Further, the terminal station apparatus includes a scanning platform having a scanning window and an optical scanner operable to scan through the scanning window a visual object identifier code disposed on an object while transferred over the scanning window. The POS system device is operationally coupled to an optical sensor device having an optical sensor with a field of view that includes a region about the POS system device and operable to capture an image that includes the POS region. The POS region includes a set of POS subregions including a POS subregion associated with the scanning window and a POS subregion associated with the bagging area. In addition, the POS system device further includes processing circuitry and a memory with the memory containing instructions executable by the processing circuitry whereby the processing circuitry is configured to obtain data that represents a set of successive images of the POS region captured by the optical sensor device as first and second target objects are moved in the POS region to enable a determination that the first target object is transferred to the POS subregion associated with the bagging area without being scanned while the second target object is contemporaneously scanned without being transferred to the POS subregion associated with the bagging area based on a set of predetermined criteria associated with the set of POS subregions, a first object movement track associated with the first target object and a second object movement track associated with the second target object. Further, each track includes a set of successive object locations of the corresponding target object as that target object is moved in the POS region.

In another exemplary embodiment, the memory can include further instructions executable by the processing circuitry whereby the processing circuitry is configured to receive, from the optical sensor, the successive image data.

In another exemplary embodiment, the memory can include further instructions executable by the processing circuitry whereby the processing circuitry is configured to determine, for the set of successive images, the set of successive object locations of each target object in the POS region based on the successive image data and determine each object movement track based on the set of successive object locations of the corresponding target object.

In another exemplary embodiment, the memory can include further instructions executable by the processing circuitry whereby the processing circuitry is configured to detect, based on the successive image data, activity in a POS subregion of the set of POS subregions that is associated with a container configured to contain an object and determine that the activity in that POS subregion corresponds to the first or second target object being transferred from or placed in the container based on the successive image data and the POS subregion associated with the container.

In another exemplary embodiment, the memory can include further instructions executable by the processing circuitry whereby the processing circuitry is configured to identify the first or second target object as starting or ending the corresponding object movement track in the POS subregion associated with the container.

In another exemplary embodiment, the memory can include further instructions executable by the processing circuitry whereby the processing circuitry is configured to identify at least one of the set of POS subregions that corresponds to each movement track of the corresponding target object.

In another exemplary embodiment, the memory can include further instructions executable by the processing circuitry whereby the processing circuitry is configured to determine, based on the set of predetermined criteria, the first and second object movement tracks and the set of POS subregions, that the first target object is transferred to the POS subregion associated with the bagging area without being scanned while the second target object is contemporaneously scanned without being transferred to the POS subregion associated with the bagging area.

In another exemplary embodiment, the memory includes further instructions executable by the processing circuitry whereby the processing circuitry is configured to: receive, by the processing circuitry, from the optical scanner, an indication associated with a scan of the visual object identifier code disposed on an object; determine an object distance between each target object and the POS subregion associated with the scanning window based on the corresponding object movement track and the POS subregion associated with the scanning window; and determine that the second target object is scanned responsive to determining that the second target object is closest to the POS subregion associated with the scanning window based on the object distances of the first and second target objects.

In another exemplary embodiment, the memory can include further instructions executable by the processing circuitry whereby the processing circuitry is configured to receive, from the optical scanner, an indication associated with a scan of the visual object identifier code disposed on an object and determine that the second target object is scanned responsive to determining that the first object movement track of the first object does not correspond to the POS subregion associated with the scanning window and the second object movement track of the second object does correspond to the POS subregion associated with the scanning window.

In one exemplary embodiment, a POS system includes a terminal station apparatus having a scanning platform that includes a scanning window and an optical scanner device operable to scan through the scanning window a visual object identifier code disposed on an object while transferred over the scanning window; a bagging station apparatus having a bagging area; and an optical sensor device having an optical sensor with a field of view that includes a region about the POS system and operable to capture an image that includes the POS region, with the POS region having a set of POS subregions including a POS subregion associated with the scanning window and a POS subregion associated with the bagging area. The POS system can further include a processing circuitry and a memory containing instructions executable by the processing circuitry whereby the processing circuitry is operative to obtain data that represents a set of successive images of the POS region captured by the optical sensor device as first and second target objects are moved in the POS region to enable a determination that the first target object is transferred to the POS subregion associated with the bagging area without being scanned while the second target object is contemporaneously scanned without being transferred to the POS subregion associated with the bagging area based on a set of predetermined criteria associated with the set of POS subregions, a first object movement track associated with the first target object and a second object movement track associated with the second target object. In addition, each track includes a set of successive object locations of the corresponding target object as that target object is moved in the POS region.

In one exemplary embodiment, a method is performed by a POS system device having a terminal station apparatus and a bagging station apparatus with a bagging area. The terminal station apparatus includes a scanning platform having a scanning window and an optical scanner operable to scan through the scanning window a visual object identifier code disposed on an object while transferred over the scanning window. The POS system device is operationally coupled to an optical sensor device having an optical sensor with a field of view that includes a region about the POS system device and is operable to capture a successive image that includes the POS region. Further, the POS region includes a set of POS subregions with a POS subregion associated with the scanning window and a POS subregion associated with the bagging area. The method includes selecting, based on one of a set of customer trust levels associated with a current transaction, one set of sets of predetermined criteria to enable a determination that a target object of the current transaction is transferred to the POS subregion associated with the bagging area with or without being scanned based on the selected set of predetermined criteria. Each customer trust level is associated with one set of the sets of predetermined criteria.

In another exemplary embodiment, the method can further include obtaining the one of the set of customer trust levels based on information related to a customer account associated with the current transaction.

In another exemplary embodiment, the customer account information can be related to a transaction history associated with the customer account, a customer profile associated with the customer account, or the like.

In another exemplary embodiment, each set of predetermined criteria can be associated with a certain likelihood of a false positive determination that the target object is transferred to the POS subregion associated with the bagging area without being scanned.

In another exemplary embodiment, each set of predetermined criteria can be associated with a same likelihood of a true positive determination that the target object is transferred to the POS subregion associated with the bagging area without being scanned.

In another exemplary embodiment, the method can further include obtaining data that represents a set of successive images of the POS region captured by the optical sensor device as a target object is moved in the POS region. The method can further include determining that the target object is transferred to the POS subregion associated with the bagging area with or without being scanned based on the selected set of predetermined criteria, the set of POS subregions and an object movement track having a set of successive object locations of the target object as the target object is moved in the POS region. In addition, each successive location can be related to a certain one of the set of successive images of the POS region.

In another exemplary embodiment, each set of predetermined criteria can include a predetermined criteria associated with a detection of a first scanned object in the POS subregion associated with the scanning window while a second unscanned object is contemporaneously placed in the POS subregion associated with the bagging area.

In another exemplary embodiment, each set of predetermined criteria can include a predetermined criteria associated with a frame rate of the successive image.

In another exemplary embodiment, each set of predetermined criteria can include a predetermined criteria associated with an area of at least one of the set of POS subregions.

In one exemplary embodiment, a POS system device includes a terminal station apparatus and a bagging station apparatus with a bagging area. The terminal station apparatus includes a scanning platform having a scanning window and an optical scanner operable to scan through the scanning window a visual object identifier code disposed on an object while transferred over the scanning window. The POS system device is operationally coupled to an optical sensor device having an optical sensor with a field of view that includes a region about the POS system device and is operable to capture a successive image that includes the POS region. The POS region includes a set of POS subregions with a POS subregion associated with the scanning window and a POS subregion associated with the bagging area. In addition, the POS system device further includes processing circuitry and a memory with the memory containing instructions executable by the processing circuitry whereby the processing circuitry is configured to select, based on one of a set of customer trust levels associated with a current transaction, one set of sets of predetermined criteria to enable a determination that a target object of the current transaction is transferred to the POS subregion associated with the bagging area with or without being scanned based on the selected set of predetermined criteria. Each customer trust level is associated with one set of the sets of predetermined criteria.

In another exemplary embodiment, the memory can include further instructions executable by the processing circuitry whereby the processing circuitry is configured to obtain the one of the set of customer trust levels based on information related to a customer account associated with the current transaction.

In another exemplary embodiment, the memory can include further instructions executable by the processing circuitry whereby the processing circuitry is configured to obtain data that represents a set of successive images of the POS region captured by the optical sensor device as a target object is moved in the POS region or determine that the target object is transferred to the POS subregion associated with the bagging area with or without being scanned based on the selected set of predetermined criteria, the set of POS subregions and an object movement track having a set of successive object locations of the target object as the target object is moved in the POS region. Further, each successive location can be related to a certain one of the set of successive images of the POS region.

In one exemplary embodiment, a POS system includes a terminal station apparatus having a scanning platform that includes a scanning window and an optical scanner device operable to scan through the scanning window a visual object identifier code disposed on an object while transferred over the scanning window. The POS system also includes a bagging station apparatus having a bagging area and an optical sensor device having an optical sensor with a field of view that includes a region about the POS system and is operable to capture an image that includes the POS region. The POS region includes a set of POS subregions with a POS subregion associated with the scanning window and a POS subregion associated with the bagging area. In addition, the POS system includes a processing circuitry and a memory containing instructions executable by the processing circuitry whereby the processing circuitry is operative to select, based on one of a set of customer trust levels associated with a current transaction, one set of sets of predetermined criteria to enable a determination that a target object of the current transaction is transferred to the POS subregion associated with the bagging area with or without being scanned based on the selected set of predetermined criteria. Each customer trust level is associated with one set of the sets of predetermined criteria.

In one exemplary embodiment, a method comprises, by a POS system device having a terminal station apparatus and a bagging station apparatus with a bagging area, the POS system device being operatively coupled to an optical sensor device having an optical sensor with a field of view that includes a region about the POS system device and configured to capture data of a sequential image that includes a POS region, with the POS region having a set of POS subregions including a POS subregion associated with the terminal station apparatus, a POS subregion associated with the bagging area, and a POS subregion associated with an exit region of the POS region, the POS system device further being operatively coupled to a payment terminal and to a POS transaction logic configured to maintain transaction data for a checkout transaction by the POS system, obtaining data that represents a successive image of the POS region captured by the optical sensor device as a customer and one or more target objects are present in the POS region, determining, based on the successive image data, customer location data that represents a set of successive locations associated with the customer present in the POS region, and determining a customer location track based on the customer location data, determining, based on the successive image data, for each target object, a corresponding object movement track in the POS region, obtaining, from the POS transaction logic, transaction data associated with the transaction, the transaction data including one or more item entries corresponding to objects registered in the transaction and a transaction state, obtaining, from the payment terminal, payment state information associated with the transaction indicative of whether payment for the transaction has been completed, determining, based on the customer location track and the set of POS subregions, that the customer location track includes at least one customer location associated with the POS subregion associated with the exit region, identifying, based on the object movement tracks and the set of POS subregions, that at least one target object is located within a possession region associated with the customer location track while the customer location track includes the at least one customer location associated with the POS subregion associated with the exit region, verifying, based on a correlation between the at least one target object located within the possession region associated with the customer location track and the transaction data and the payment state information, that the at least one target object lacks a corresponding item entry in the transaction data or is associated with the transaction while payment for the transaction has not been completed, and, responsive to determining that the at least one target object located within the possession region associated with the customer location track lacks the corresponding item entry in the transaction data or that payment for the transaction has not been completed, generating an indication of a potential non-payment event associated with the customer.

In another exemplary embodiment, the step of determining the customer location data can include determining, for each successive image of the successive image data, a customer location associated with the customer in the POS region.

In another exemplary embodiment, the step of identifying that the at least one target object is located within the possession region associated with the customer location track can include determining that the at least one target object is located within a threshold distance of at least one customer location of the customer location track.

In another exemplary embodiment, the step of determining that the at least one target object is located within the possession region associated with the customer location track can further include determining that the at least one target object is located in at least one of a cart associated with the customer, a basket associated with the customer, or a hand region associated with the customer.

In another exemplary embodiment, the method can further comprise, prior to determining that the customer location track includes the at least one customer location associated with the POS subregion associated with the exit region, determining, based on the customer location track and the set of POS subregions, that the customer location track includes at least one customer location associated with the POS subregion associated with the terminal station apparatus or the POS subregion associated with the bagging area.

In another exemplary embodiment, the step of obtaining the payment state information associated with the transaction indicative of whether payment for the transaction has been completed can further include obtaining payment state information indicative of whether payment for the transaction has been initiated, and determining that the at least one target object is associated with the transaction while payment for the transaction has not been completed can include determining that the payment for the transaction has been initiated but not completed.

In another exemplary embodiment, the step of verifying that the at least one target object is associated with the transaction while payment for the transaction has not been completed can include determining, based on the corresponding object movement track of the at least one target object and the transaction data, that the at least one target object is associated with at least one item entry of the one or more item entries registered in the transaction.

In another exemplary embodiment, the step of determining, based on the correlation between the at least one target object located within the possession region associated with the customer location track and the transaction data, that the at least one target object lacks the corresponding item entry in the transaction data can include determining that no item entry of the one or more item entries corresponds to the at least one target object based on a time correlation between the corresponding object movement track and item registration events of the transaction or a spatial correlation between the corresponding object movement track and a scanning region associated with the terminal station apparatus.

In another exemplary embodiment, the step of generating the indication of the potential non-payment event associated with the customer can include selecting, from the successive image data, one or more images that depict the customer location track in the POS subregion associated with the exit region and depict the at least one target object located within the possession region associated with the customer location track, and sending, to an associate network node device configured to receive alert data, alert data that includes at least one of the one or more images, an identifier of the transaction, an identifier of the terminal station apparatus, or information describing the at least one target object determined to be associated with the potential non-payment event.

In another exemplary embodiment, the method can further comprise storing, in a data store associated with the POS system device, an event record associated with the indication of the potential non-payment event, the event record including data that identifies at least one of the customer location track, the corresponding object movement track of the at least one target object, the transaction data associated with the transaction, or a subset of the successive image data associated with the potential non-payment event.

In one exemplary embodiment, a POS system device can comprise a terminal station apparatus, a bagging station apparatus having a bagging area, an optical sensor device having an optical sensor with a field of view that includes a region about the POS system device and configured to capture data of a successive image that includes a POS region, the POS region having a set of POS subregions including a POS subregion associated with the terminal station apparatus, a POS subregion associated with the bagging area, and a POS subregion associated with an exit region of the POS region, a payment terminal, a POS transaction logic configured to maintain transaction data for a checkout transaction by the POS system, the transaction data including one or more item entries corresponding to objects registered in the transaction and a transaction state, processing circuitry, and a memory operatively coupled to the processing circuitry and storing instructions that, when executed by the processing circuitry, cause the POS system device to obtain successive image data of the POS region captured by the optical sensor device as a customer and one or more target objects are present in the POS region, determine, based on the successive image data, customer location data that represents a set of successive locations associated with the customer present in the POS region, and determine a customer location track based on the customer location data, determine, based on the successive image data, for each of the one or more target objects, a corresponding object movement track in the POS region, obtain, from the POS transaction logic, the transaction data associated with the transaction, obtain, from the payment terminal, payment state information associated with the transaction indicative of whether payment for the transaction has been completed, determine, based on the customer location track and the set of POS subregions, that the customer location track includes at least one customer location associated with the POS subregion associated with the exit region, identify, based on the object movement tracks and the set of POS subregions, that at least one target object is located within a possession region associated with the customer location track while the customer location track includes the at least one customer location associated with the POS subregion associated with the exit region, determine, based on a correlation between the at least one target object located within the possession region associated with the customer location track and the transaction data and the payment state information, that the at least one target object lacks a corresponding item entry in the transaction data or is associated with the transaction while payment for the transaction has not been completed, and, responsive to determining that the at least one target object located within the possession region associated with the customer location track lacks the corresponding item entry in the transaction data or that payment for the transaction has not been completed, generate an indication of a potential non-payment event associated with the customer.

In another exemplary embodiment, the memory can include further instructions executable by the processing circuitry whereby the processing circuitry is configured to determine, for each successive image of the successive image data, a customer location associated with the customer in the POS region when determining the customer location data.

In another exemplary embodiment, the memory can include further instructions executable by the processing circuitry whereby the processing circuitry is configured to determine that the at least one target object is located within the possession region associated with the customer location track by determining that the at least one target object is located within a threshold distance of at least one customer location of the customer location track.

In another exemplary embodiment, the memory can include further instructions executable by the processing circuitry whereby the processing circuitry is configured to determine that the at least one target object is located within the possession region associated with the customer location track by determining that the at least one target object is located in at least one of a cart associated with the customer, a basket associated with the customer, or a hand region associated with the customer.

In another exemplary embodiment, the memory can include further instructions executable by the processing circuitry whereby the processing circuitry is configured to, prior to determining, based on the customer location track and the set of POS subregions, that the customer location track includes the at least one customer location associated with the POS subregion associated with the exit region, determine, based on the customer location track and the set of POS subregions, that the customer location track includes at least one customer location associated with the POS subregion associated with the terminal station apparatus or the POS subregion associated with the bagging area.

In another exemplary embodiment, the memory can include further instructions executable by the processing circuitry whereby the processing circuitry is configured to obtain payment state information indicative of whether payment for the transaction has been initiated in addition to the payment state information indicative of whether payment for the transaction has been completed, and determine that the at least one target object is associated with the transaction while payment for the transaction has not been completed by determining that payment for the transaction has been initiated but not completed.

In another exemplary embodiment, the memory can include further instructions executable by the processing circuitry whereby the processing circuitry is configured to determine, based on the corresponding object movement track of the at least one target object and the transaction data, that the at least one target object is associated with at least one item entry of the one or more item entries registered in the transaction when determining, based on the correlation between the at least one target object located within the possession region associated with the customer location track and the transaction data, that the at least one target object is associated with the transaction while payment for the transaction has not been completed.

In another exemplary embodiment, the memory can include further instructions executable by the processing circuitry whereby the processing circuitry is configured to determine that no item entry of the one or more item entries corresponds to the at least one target object based on a time correlation between the corresponding object movement track and item registration events of the transaction or a spatial correlation between the corresponding object movement track and a scanning region associated with the terminal station apparatus when determining, based on the correlation between the at least one target object located within the possession region associated with the customer location track and the transaction data, that the at least one target object lacks a corresponding item entry in the transaction data.

In another exemplary embodiment, the memory can include further instructions executable by the processing circuitry whereby the processing circuitry is configured to select, from the successive image data, one or more images that depict the customer location track in the POS subregion associated with the exit region and depict the at least one target object located within the possession region associated with the customer location track, send, to an associate network node device, alert data that includes at least one of the one or more images, an identifier of the transaction, an identifier of the terminal station apparatus, or information describing the at least one target object determined to be associated with the potential non-payment event, and store, in a data store associated with the POS system device, an event record associated with the indication of the potential non-payment event, the event record including data that identifies at least one of the customer location track, the corresponding object movement track of the at least one target object, the transaction data associated with the transaction, or a subset of the successive image data associated with the potential non-payment event.

In one exemplary embodiment, a system can comprise an associate network node device and a POS system device communicatively coupled over a network to the associate network node device and including a terminal station apparatus, a bagging station apparatus having a bagging area, an optical sensor device having an optical sensor with a field of view that includes a region about the terminal station apparatus and the bagging station apparatus and configured to capture successive image data that includes a POS region, the POS region having a set of POS subregions including a POS subregion associated with the terminal station apparatus, a POS subregion associated with the bagging area, and a POS subregion associated with an exit region of the POS region, a payment terminal, a POS transaction logic configured to maintain transaction data for a checkout transaction by the POS system, the transaction data including one or more item entries corresponding to objects registered in the transaction and a transaction state, processing circuitry, and a memory operatively coupled to the processing circuitry and storing instructions that, when executed by the processing circuitry, cause the POS system to obtain successive image data of the POS region captured by the optical sensor device as a customer and one or more target objects are present in the POS region, determine, based on the successive image data, customer location data that represents a set of successive locations associated with the customer present in the POS region, and determine a customer location track based on the customer location data, determine, based on the successive image data, for each of the one or more target objects, a corresponding object movement track in the POS region, obtain, from the POS transaction logic, the transaction data associated with the transaction, obtain, from the payment terminal, payment state information associated with the transaction indicative of whether payment for the transaction has been completed, determine, based on the customer location track and the set of POS subregions, that the customer location track includes at least one customer location associated with the POS subregion associated with the exit region, identify, based on the object movement tracks and the set of POS subregions, that at least one target object is located within a possession region associated with the customer location track while the customer location track includes the at least one customer location associated with the POS subregion associated with the exit region, determine, based on a correlation between the at least one target object located within the possession region associated with the customer location track and the transaction data and the payment state information, that the at least one target object lacks a corresponding item entry in the transaction data or is associated with the transaction while payment for the transaction has not been completed, responsive to determining that the at least one target object located within the possession region associated with the customer location track lacks the corresponding item entry in the transaction data or that payment for the transaction has not been completed, generate alert data associated with an indication of a potential non-payment event associated with the customer, and send, over the communication network, to the associate network node device, an indication that includes the alert data, and wherein the associate network node device includes processing circuitry and a memory storing instructions that, when executed by the processing circuitry, cause the associate network node device to receive, over the communication network from the POS system, the indication and obtain the alert data from the indication, and process the alert data to cause presentation of an alert via a user interface of the associate network node device, the alert indicating the potential non-payment event associated.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein.

Throughout the specification and the embodiments, the following terms take at least the meanings explicitly associated herein, unless the context clearly dictates otherwise. Relational terms such as “first” and “second," and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a point of sale (POS) system device having a terminal station apparatus and a bagging station apparatus with a bagging area, the POS system device being operatively coupled to an optical sensor device having an optical sensor with a field of view that includes a region about the POS system device and configured to capture data of a sequential image that includes a POS region, with the POS region having a set of POS subregions including a POS subregion associated with the terminal station apparatus, a POS subregion associated with the bagging area, and a POS subregion associated with an exit region of the POS region, the POS system device further being operatively coupled to a payment terminal and to a POS transaction logic configured to maintain transaction data for a checkout transaction by the POS system,
obtaining data that represents a successive image of the POS region captured by the optical sensor device as a customer and one or more target objects are present in the POS region;
determining, based on the successive image data, customer location data that represents a set of successive locations associated with the customer present in the POS region, and determining a customer location track based on the customer location data;
determining, based on the successive image data, for each target object, a corresponding object movement track in the POS region;
obtaining, from the POS transaction logic, transaction data associated with the transaction, the transaction data including one or more item entries corresponding to objects registered in the transaction and a transaction state;
obtaining, from the payment terminal, payment state information associated with the transaction indicative of whether payment for the transaction has been completed;
determining, based on the customer location track and the set of POS subregions, that the customer location track includes at least one customer location associated with the POS subregion associated with the exit region;
identifying, based on the object movement tracks and the set of POS subregions, that at least one target object is located within a possession region associated with the customer location track while the customer location track includes the at least one customer location associated with the POS subregion associated with the exit region;
verifying, based on a correlation between the at least one target object located within the possession region associated with the customer location track and the transaction data and the payment state information, that the at least one target object lacks a corresponding item entry in the transaction data or is associated with the transaction while payment for the transaction has not been completed; and
responsive to determining that the at least one target object located within the possession region associated with the customer location track lacks the corresponding item entry in the transaction data or that payment for the transaction has not been completed, generating an indication of a potential non-payment event associated with the customer.

2. The method of claim 1, wherein the determining the customer location data includes:
determining, for each successive image of the successive image data, a customer location associated with the customer in the POS region.

3. The method of claim 1, wherein the identifying that the at least one target object is located within the possession region associated with the customer location track includes:
determining that the at least one target object is located within a threshold distance of at least one customer location of the customer location track.

4. The method of claim 3, wherein the determining that the at least one target object is located within the possession region associated with the customer location track further includes:
determining that the at least one target object is located in at least one of a cart associated with the customer, a basket associated with the customer, or a hand region associated with the customer.

5. The method of claim 1, further comprising:
prior to determining that the customer location track includes the at least one customer location associated with the POS subregion associated with the exit region, determining, based on the customer location track and the set of POS subregions, that the customer location track includes at least one customer location associated with the POS subregion associated with the terminal station apparatus or the POS subregion associated with the bagging area.

6. The method of claim 1, wherein the obtaining the payment state information associated with the transaction indicative of whether payment for the transaction has been completed further includes:
obtaining payment state information indicative of whether payment for the transaction has been initiated; and
wherein the determining that the at least one target object is associated with the transaction while payment for the transaction has not been completed includes:
determining that the payment for the transaction has been initiated but not completed.

7. The method of claim 1, wherein the verifying that the at least one target object is associated with the transaction while payment for the transaction has not been completed includes:
determining, based on the corresponding object movement track of the at least one target object and the transaction data, that the at least one target object is associated with at least one item entry of the one or more item entries registered in the transaction.

8. The method of claim 1, wherein the determining, based on the correlation between the at least one target object located within the possession region associated with the customer location track and the transaction data, that the at least one target object lacks the corresponding item entry in the transaction data includes:
determining that no item entry of the one or more item entries corresponds to the at least one target object based on a time correlation between the corresponding object movement track and item registration events of the transaction or a spatial correlation between the corresponding object movement track and a scanning region associated with the terminal station apparatus.

9. The method of claim 1, wherein the generating the indication of the potential non-payment event associated with the customer includes:
selecting, from the successive image data, one or more images that depict the customer location track in the POS subregion associated with the exit region and depict the at least one target object located within the possession region associated with the customer location track; and
sending, to an associate network node device configured to receive alert data, alert data that includes at least one of the one or more images, an identifier of the transaction, an identifier of the terminal station apparatus, or information describing the at least one target object determined to be associated with the potential non-payment event.

10. The method of claim 1, further comprising:
storing, in a data store associated with the POS system device, an event record associated with the indication of the potential non-payment event, the event record including data that identifies at least one of the customer location track, the corresponding object movement track of the at least one target object, the transaction data associated with the transaction, or a subset of the successive image data associated with the potential non-payment event.

11. A point of sale (POS) system device, comprising:
a terminal station apparatus;
a bagging station apparatus having a bagging area;
an optical sensor device having an optical sensor with a field of view that includes a region about the POS system device and configured to capture data of a successive image that includes a POS region, the POS region having a set of POS subregions including a POS subregion associated with the terminal station apparatus, a POS subregion associated with the bagging area, and a POS subregion associated with an exit region of the POS region;
a payment terminal;
a POS transaction logic configured to maintain transaction data for a checkout transaction by the POS system, the transaction data including one or more item entries corresponding to objects registered in the transaction and a transaction state;
processing circuitry; and
a memory operatively coupled to the processing circuitry and storing instructions that, when executed by the processing circuitry, cause the POS system device to:
obtain successive image data of the POS region captured by the optical sensor device as a customer and one or more target objects are present in the POS region;
determine, based on the successive image data, customer location data that represents a set of successive locations associated with the customer present in the POS region, and determine a customer location track based on the customer location data;
determine, based on the successive image data, for each of the one or more target objects, a corresponding object movement track in the POS region;
obtain, from the POS transaction logic, the transaction data associated with the transaction;
obtain, from the payment terminal, payment state information associated with the transaction indicative of whether payment for the transaction has been completed;
determine, based on the customer location track and the set of POS subregions, that the customer location track includes at least one customer location associated with the POS subregion associated with the exit region;
identify, based on the object movement tracks and the set of POS subregions, that at least one target object is located within a possession region associated with the customer location track while the customer location track includes the at least one customer location associated with the POS subregion associated with the exit region;
determine, based on a correlation between the at least one target object located within the possession region associated with the customer location track and the transaction data and the payment state information, that the at least one target object lacks a corresponding item entry in the transaction data or is associated with the transaction while payment for the transaction has not been completed; and
responsive to determining that the at least one target object located within the possession region associated with the customer location track lacks the corresponding item entry in the transaction data or that payment for the transaction has not been completed, generate an indication of a potential non-payment event associated with the customer.

12. The device of claim 11, wherein the memory includes further instructions executable by the processing circuitry whereby the processing circuitry is configured to:
determine, for each successive image of the successive image data, a customer location associated with the customer in the POS region when determining the customer location data.

13. The POS system device of claim 11, wherein the memory includes further instructions executable by the processing circuitry whereby the processing circuitry is configured to:
determine that the at least one target object is located within the possession region associated with the customer location track by determining that the at least one target object is located within a threshold distance of at least one customer location of the customer location track.

14. The POS system device of claim 13, wherein the memory includes further instructions executable by the processing circuitry whereby the processing circuitry is configured to:
determine that the at least one target object is located within the possession region associated with the customer location track by determining that the at least one target object is located in at least one of a cart associated with the customer, a basket associated with the customer, or a hand region associated with the customer.

15. The POS system device of claim 11, wherein the memory includes further instructions executable by the processing circuitry whereby the processing circuitry is configured to:
prior to determining, based on the customer location track and the set of POS subregions, that the customer location track includes the at least one customer location associated with the POS subregion associated with the exit region, determine, based on the customer location track and the set of POS subregions, that the customer location track includes at least one customer location associated with the POS subregion associated with the terminal station apparatus or the POS subregion associated with the bagging area.

16. The POS system device of claim 11, wherein the memory includes further instructions executable by the processing circuitry whereby the processing circuitry is configured to:
obtain payment state information indicative of whether payment for the transaction has been initiated in addition to the payment state information indicative of whether payment for the transaction has been completed; and
determine that the at least one target object is associated with the transaction while payment for the transaction has not been completed by determining that payment for the transaction has been initiated but not completed.

17. The POS system device of claim 11, wherein the memory includes further instructions executable by the processing circuitry whereby the processing circuitry is configured to:
determine, based on the corresponding object movement track of the at least one target object and the transaction data, that the at least one target object is associated with at least one item entry of the one or more item entries registered in the transaction when determining, based on the correlation between the at least one target object located within the possession region associated with the customer location track and the transaction data, that the at least one target object is associated with the transaction while payment for the transaction has not been completed.

18. The POS system device of claim 11, wherein the memory includes further instructions executable by the processing circuitry whereby the processing circuitry is configured to:
determine that no item entry of the one or more item entries corresponds to the at least one target object based on a time correlation between the corresponding object movement track and item registration events of the transaction or a spatial correlation between the corresponding object movement track and a scanning region associated with the terminal station apparatus when determining, based on the correlation between the at least one target object located within the possession region associated with the customer location track and the transaction data, that the at least one target object lacks a corresponding item entry in the transaction data.

19. The POS system device of claim 11, wherein the memory includes further instructions executable by the processing circuitry whereby the processing circuitry is configured to:
select, from the successive image data, one or more images that depict the customer location track in the POS subregion associated with the exit region and depict the at least one target object located within the possession region associated with the customer location track;
send, to an associate network node device, alert data that includes at least one of the one or more images, an identifier of the transaction, an identifier of the terminal station apparatus, or information describing the at least one target object determined to be associated with the potential non-payment event; and
store, in a data store associated with the POS system device, an event record associated with the indication of the potential non-payment event, the event record including data that identifies at least one of the customer location track, the corresponding object movement track of the at least one target object, the transaction data associated with the transaction, or a subset of the successive image data associated with the potential non-payment event.

20. A system, comprising:
an associate network node device; and
a point of sale (POS) system device communicatively coupled over a network to the associate network node device and including:
a terminal station apparatus;
a bagging station apparatus having a bagging area;
an optical sensor device having an optical sensor with a field of view that includes a region about the terminal station apparatus and the bagging station apparatus and configured to capture successive image data that includes a POS region, the POS region having a set of POS subregions including a POS subregion associated with the terminal station apparatus, a POS subregion associated with the bagging area, and a POS subregion associated with an exit region of the POS region;
a payment terminal;
a POS transaction logic configured to maintain transaction data for a checkout transaction by the POS system, the transaction data including one or more item entries corresponding to objects registered in the transaction and a transaction state;
processing circuitry; and
a memory operatively coupled to the processing circuitry and storing instructions that, when executed by the processing circuitry, cause the POS system to:
obtain successive image data of the POS region captured by the optical sensor device as a customer and one or more target objects are present in the POS region;
determine, based on the successive image data, customer location data that represents a set of successive locations associated with the customer present in the POS region, and determine a customer location track based on the customer location data;
determine, based on the successive image data, for each of the one or more target objects, a corresponding object movement track in the POS region;
obtain, from the POS transaction logic, the transaction data associated with the transaction;
obtain, from the payment terminal, payment state information associated with the transaction indicative of whether payment for the transaction has been completed;
determine, based on the customer location track and the set of POS subregions, that the customer location track includes at least one customer location associated with the POS subregion associated with the exit region;
identify, based on the object movement tracks and the set of POS subregions, that at least one target object is located within a possession region associated with the customer location track while the customer location track includes the at least one customer location associated with the POS subregion associated with the exit region;
determine, based on a correlation between the at least one target object located within the possession region associated with the customer location track and the transaction data and the payment state information, that the at least one target object lacks a corresponding item entry in the transaction data or is associated with the transaction while payment for the transaction has not been completed;
responsive to determining that the at least one target object located within the possession region associated with the customer location track lacks the corresponding item entry in the transaction data or that payment for the transaction has not been completed, generate alert data associated with an indication of a potential non-payment event associated with the customer; and
send, over the communication network, to the associate network node device, an indication that includes the alert data; and
wherein the associate network node device includes processing circuitry and a memory storing instructions that, when executed by the processing circuitry, cause the associate network node device to:
receive, over the communication network from the POS system, the indication and obtain the alert data from the indication; and
process the alert data to cause presentation of an alert via a user interface of the associate network node device, the alert indicating the potential non-payment event associated.
